(19) United States
(12) Patent Application Publication
(10) Pub. No.: US 2026/0186249 A1
(43) Pub. Date: Jul. 2, 2026

(54) OPTICAL LENS ASSEMBLY

(71) Applicant: GENIUS ELECTRONIC OPTICAL (XIAMEN) CO., LTD., Xiamen (CN)

(72) Inventors: Jia-Sin Jhang, Xiamen (CN); Shiyu Wu, Xiamen (CN); Feng Chen, Xiamen (CN)

(73) Assignee: GENIUS ELECTRONIC OPTICAL (XIAMEN) CO., LTD., Xiamen (CN)

(21) Appl. No.: 19/224,911

(22) Filed: Jun. 2, 2025

(30) Foreign Application Priority Data
Dec. 31, 2024 (CN) 202411977829.7

(51) Int. Cl. G02B 13/00; G02B 9/62

(52) U.S. Cl. CPC G02B 13/0045; G02B 9/62

(57) ABSTRACT

An optical lens assembly is adapted to a projection lens and configured to generate beams from lights emitted by a multiple light source generating unit. A direction toward the multiple light source generating unit is a light input side, and an opposite side is a light output side. The optical lens assembly includes first to sixth lens elements sequentially along an optical axis from the light output side to the light input side. Each lens element includes a light output surface facing the light output side and a light input surface facing the light input side. The first and fourth lens elements have negative refracting power. A periphery region of the light output surface of the fifth lens element is concave. A periphery region of the light input surface of the sixth lens element is convex. The projection lens and the optical lens assembly respectively satisfy EDmax/EDmin≤2.100; and V1+V2+V3≤140.

### CROSS-REFERENCE TO RELATED APPLICATION

This application claims the priority benefit of China application serial no. 202411977829.7, filed on Dec. 31, 2024. The entirety of the above-mentioned patent application is hereby incorporated by reference herein and made a part of this specification.

### BACKGROUND

### Technical Field

The disclosure relates to an electronic device, and more particularly to an optical lens assembly.

### Description of Related Art

Specifications of portable electronic devices are changing with each passing day, and key components, that is, optical lens assemblies, are also becoming more diversified. With the popularization of virtual reality (VR) or augmented reality (AR), the development of near-eye displays and peripheral devices has also accelerated. Therefore, in addition to being used for shooting and recording, the optical lens assembly may also be designed to utilize the principle of optical reflection to project an image light or a sensing light onto the lens of the near-eye display or onto the eyes, and then reflect the image or sensing light into the eyes of a user or a sensor to achieve augmented reality or eyeball tracking.

However, in order to achieve the optimal ratio between optimal ray collection and projection imaging of the projection lens, the optical lens assembly also needs to be continuously improved in design to improve optical imaging quality. How to achieve the above conditions has also become a major challenge for related manufacturers.

### SUMMARY

The disclosure provides an optical lens assembly adapted to a projection lens to improve projection effects.

An embodiment of the disclosure provides an optical lens assembly adapted to a projection lens. The optical lens assembly is configured to generate multiple beams from multiple lights emitted by a multiple light source generating unit via the optical lens assembly. A direction toward the multiple light source generating unit is a light input side, and an opposite side is a light output side. The optical lens assembly includes a first lens element, a second lens element, a third lens element, a fourth lens element, a fifth lens element, and a sixth lens element sequentially along an optical axis from the light output side to the light input side, and each of the first lens element to the sixth lens element includes a light output surface facing the light output side and a light input surface facing the light input side. The first lens element has negative refracting power, the fourth lens element has negative refracting power, a periphery region of the light output surface of the fifth lens element is concave, and a periphery region of the light input surface of the sixth lens element is convex. Lens elements of the optical lens assembly are only the six lens elements, and the projection lens and the optical lens assembly respectively satisfy following conditional expressions: EDmax/EDmin≤2.100; and V1+V2+V3≤140, where EDmax is a maximum effective diameter of the six lens elements, EDmin is a minimum effective diameter of the six lens elements, V1 is a Vd Abbe number of the first lens element, V2 is a Vd Abbe number of the second lens element, and V3 is a Vd Abbe number of the third lens element.

An embodiment of the disclosure provides an optical lens assembly adapted to a projection lens. The optical lens assembly is configured to generate multiple beams from multiple lights emitted by a multiple light source generating unit via the optical lens assembly. A direction toward the multiple light source generating unit is a light input side, and an opposite side is a light output side. The optical lens assembly includes a first lens element, a second lens element, a third lens element, a fourth lens element, a fifth lens element, and a sixth lens element sequentially along an optical axis from the light output side to the light input side, and each of the first lens element to the sixth lens element includes a light output surface facing the light output side and a light input surface facing the light input side. The first lens element has negative refracting power, and an optical axis region of the light output surface of the first lens element is convex. The fourth lens element has negative refracting power. A periphery region of the light output surface of the fifth lens element is concave, and an optical axis region of the light input surface of the sixth lens element is concave. Lens elements of the optical lens assembly are only the six lens elements, and the projection lens and the optical lens assembly respectively satisfy following conditional expressions: EDmax/EDmin≤2.100; and V1+V3≤100, where EDmax is a maximum effective diameter of the six lens elements, EDmin is a minimum effective diameter of the six lens elements, V1 is a Vd Abbe number of the first lens element, and V3 is a Vd Abbe number of the third lens element.

An embodiment of the disclosure provides an optical lens assembly adapted to a projection lens. The optical lens assembly is configured to generate multiple beams from multiple lights emitted by a multiple light source generating unit via the optical lens assembly. A direction toward the multiple light source generating unit is a light input side, and an opposite side is a light output side. The optical lens assembly includes a first lens element, a second lens element, a third lens element, a fourth lens element, a fifth lens element, and a sixth lens element sequentially along an optical axis from the light output side to the light input side, and each of the first lens element to the sixth lens element includes a light output surface facing the light output side and a light input surface facing the light input side. The first lens element has negative refracting power, and an optical axis region of the light output surface of the first lens element is convex. A periphery region of the light output surface of the second lens element is convex, the fourth lens element has negative refracting power, an optical axis region of the light input surface of the sixth lens element is concave, and a periphery region of the light input surface is convex. Lens elements of the optical lens assembly are only the six lens elements, and the projection lens and the optical lens assembly respectively satisfy following conditional expressions: EDmax/EDmin≤2.100; and V1+V3≤100, where EDmax is a maximum effective diameter of the six lens elements, EDmin is a minimum effective diameter of the six lens elements, V1 is a Vd Abbe number of the first lens element, and V3 is a Vd Abbe number of the third lens element.

Based on the above, the beneficial effect of the optical lens assembly according to the embodiments of the disclosure is that by satisfying the conditional expression: EDmax/EDmin≤2.100 and the other conditional expressions, and the conditions of the arrangement design of the concave-convex curved surfaces and the refracting powers of the lens elements, the optical lens assembly may effectively collect the chief ray and the marginal ray emitted by the image light source from the light input side, so that the above beams may be projected to the light output side with a high ratio to improve the image effect of the projection lens. In addition, the aberration of the central field of view of the imaging plane may also be corrected, so when the optical lens assembly is adapted to the projection lens, improved chromatic aberration and improved projection image quality may be provided.

In order for the features and advantages of the disclosure to be more comprehensible, the following specific embodiments are described in detail in conjunction with the accompanying drawings.

### BRIEF DESCRIPTION OF THE DRAWINGS

FIG. 1A is a schematic view illustrating an optical lens assembly of the disclosure adapted to a projection lens.

FIG. 1B is a front view of a multiple light source generating unit in FIG. 1A according to an embodiment.

FIG. 2 is a schematic view illustrating a surface structure of a lens element.

FIG. 3 is a schematic view illustrating a surface concave-convex structure and a ray focal point of a lens element.

FIG. 4 is a schematic view illustrating a surface structure of a lens element according to Example 1.

FIG. 5 is a schematic view illustrating a surface structure of a lens element according to Example 2.

FIG. 6 is a schematic view illustrating a surface structure of a lens element according to Example 3.

FIG. 7 is a schematic view of an optical lens assembly according to a first embodiment of the disclosure.

FIG. 8A to FIG. 8D are diagrams of longitudinal spherical aberration and various aberrations of the optical lens assembly according to the first embodiment.

FIG. 9 shows detailed optical data of the optical lens assembly according to the first embodiment of the disclosure.

FIG. 10 shows aspheric parameters of the optical lens assembly according to the first embodiment of the disclosure.

FIG. 11 is a schematic view of an optical lens assembly according to a second embodiment of the disclosure.

FIG. 12A to FIG. 12D are diagrams of longitudinal spherical aberration and various aberrations of the optical lens assembly according to the second embodiment.

FIG. 13 shows detailed optical data of the optical lens assembly according to the second embodiment of the disclosure.

FIG. 14 shows aspheric parameters of the optical lens assembly according to the second embodiment of the disclosure.

FIG. 15 is a schematic view of an optical lens assembly according to a third embodiment of the disclosure.

FIG. 16A to FIG. 16D are diagrams of longitudinal spherical aberration and various aberrations of the optical lens assembly according to the third embodiment.

FIG. 17 shows detailed optical data of the optical lens assembly according to the third embodiment of the disclosure.

FIG. 18 shows aspheric parameters of the optical lens assembly according to the third embodiment of the disclosure.

FIG. 19 is a schematic view of an optical lens assembly according to a fourth embodiment of the disclosure.

FIG. 20A to FIG. 20D are diagrams of longitudinal spherical aberration and various aberrations of the optical lens assembly according to the fourth embodiment.

FIG. 21 shows detailed optical data of the optical lens assembly according to the fourth embodiment of the disclosure.

FIG. 22 shows aspheric parameters of the optical lens assembly according to the fourth embodiment of the disclosure.

FIG. 23 is a schematic view of an optical lens assembly according to a fifth embodiment of the disclosure.

FIG. 24A to FIG. 24D are diagrams of longitudinal spherical aberration and various aberrations of the optical lens assembly according to the fifth embodiment.

FIG. 25 shows detailed optical data of the optical lens assembly according to the fifth embodiment of the disclosure.

FIG. 26 shows aspheric parameters of the optical lens assembly according to the fifth embodiment of the disclosure.

FIG. 27 is a schematic view of an optical lens assembly according to a sixth embodiment of the disclosure.

FIG. 28A to FIG. 28D are diagrams of longitudinal spherical aberration and various aberrations of the optical lens assembly according to the sixth embodiment.

FIG. 29 shows detailed optical data of the optical lens assembly according to the sixth embodiment of the disclosure.

FIG. 30 shows aspheric parameters of the optical lens assembly according to the sixth embodiment of the disclosure.

FIG. 31 is a schematic view of an optical lens assembly according to a seventh embodiment of the disclosure.

FIG. 32A to FIG. 32D are diagrams of longitudinal spherical aberration and various aberrations of the optical lens assembly according to the seventh embodiment.

FIG. 33 shows detailed optical data of the optical lens assembly according to the seventh embodiment of the disclosure.

FIG. 34 shows aspheric parameters of the optical lens assembly according to the seventh embodiment of the disclosure.

FIG. 35 is a schematic view of an optical lens assembly according to an eighth embodiment of the disclosure.

FIG. 36A to FIG. 36D are diagrams of longitudinal spherical aberration and various aberrations of the optical lens assembly according to the eighth embodiment.

FIG. 37 shows detailed optical data of the optical lens assembly according to the eighth embodiment of the disclosure.

FIG. 38 shows aspheric parameters of the optical lens assembly according to the eighth embodiment of the disclosure.

FIG. 39 is a schematic view of an optical lens assembly according to a nineth embodiment of the disclosure.

FIG. 40A to FIG. 40D are diagrams of longitudinal spherical aberration and various aberrations of the optical lens assembly according to the nineth embodiment.

FIG. 41 shows detailed optical data of the optical lens assembly according to the nineth embodiment of the disclosure.

FIG. 42 shows aspheric parameters of the optical lens assembly according to the nineth embodiment of the disclosure.

FIG. 43 shows values of important parameters and relational expressions thereof of the optical lens assembly according to the first to third embodiments of the disclosure.

FIG. 44 shows values of important parameters and relational expressions thereof of the optical lens assembly according to the fourth to sixth embodiments of the disclosure.

FIG. 45 shows values of important parameters and relational expressions thereof of the optical lens assembly according to the seventh to nineth embodiments of the disclosure.

### DESCRIPTION OF THE EMBODIMENTS

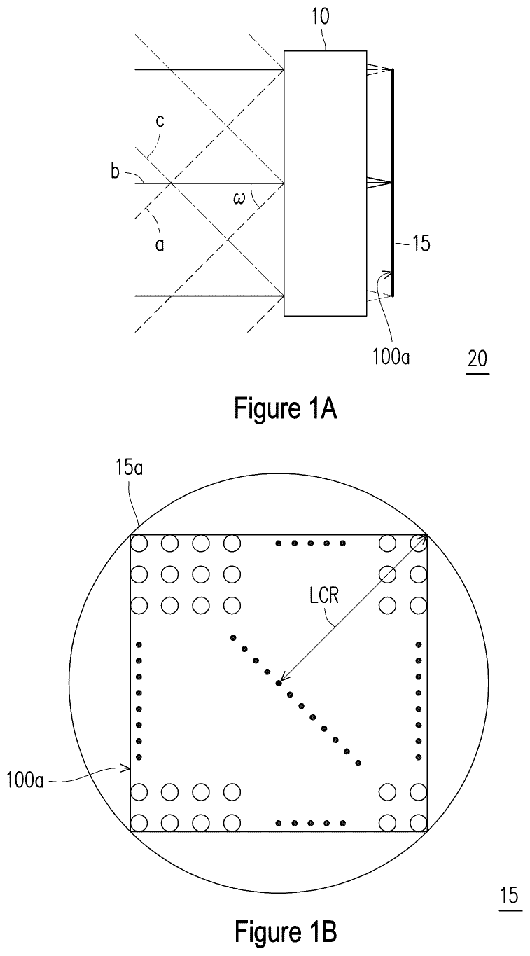

Please refer to FIG. 1A. A ray direction of a projection lens 20 is a display light or a sensing light emitted by a multiple light source generating unit 15 and multiple beams a, b, and c generated via an optical lens assembly 10 of the embodiment of the disclosure, which may be used to detect an environment in front of the projection lens 20 or as an image beam to generate an image screen. In other words, the beam a, the beam b, and the beam c are not limited to any form of beam. Here, the travelling direction of the beam is described in the form of a dotted line, and the number of the beam a, the beam b, and the beam c is not limited to 3. The number may be other numbers not equal to 3 and 1. FIG. 1A shows the beam a, the beam b, and the beam c as a representative. Please refer FIG. 1B. In an embodiment, the multiple light source generating unit 15 includes multiple light sources 15a arranged in an array. In other implementations, the arrangement manner of the light sources 15a may be a circular arrangement or other arrangement manners, and the disclosure is not limited thereto. The light source 15a may be a display light source for projecting a display light or an infrared laser light source for emitting a sensing light. Light emitting surfaces of the light sources 15a jointly form a light emitting surface 100a of the multiple light source generating unit 15.

The optical specifications of the embodiments of the disclosure described below are judged based on the assumption that the ray direction is reversely tracked, that is, a parallel ray is focused and imaged from a light output side via the optical lens assembly 10 onto the light emitting surface 100a of the multiple light source generating unit 15.

The terms “optical axis region”, “periphery region”, “concave”, and “convex” used in this specification and claims should be interpreted based on the definition listed in the specification by the principle of lexicographer.

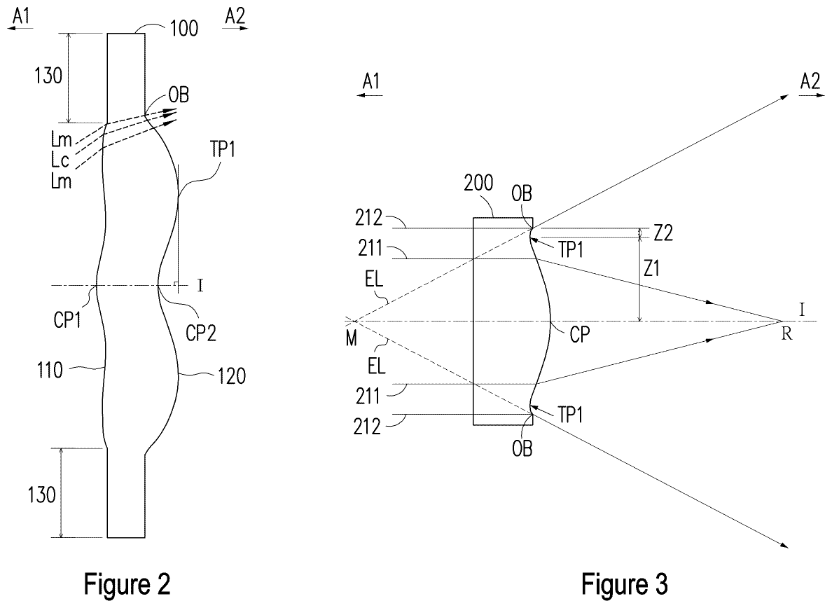

In the present disclosure, an optical lens assembly 10 may include at least one lens element to receive rays that are incident on the optical system over a set of angles ranging from parallel to an optical axis to a half field of view (HFOV) angle with respect to the optical axis. The term “a lens element having positive refracting power (or negative refracting power)” means that the paraxial refracting power of the lens element in Gaussian optics is positive (or negative). The term “a light output surface (or a light input surface) of a lens element” refers to a specific region of that surface of the lens element at which rays can pass through that specific region. Rays include at least two types of rays: a chief ray Lc and a marginal ray Lm (as shown in FIG. 2). A light output surface (or a light input surface) of a lens element may be divided into different regions, including an optical axis region, a periphery region, and, in some cases, one or more intermediate regions, according to different locations, and the regions will be discussed more fully below.

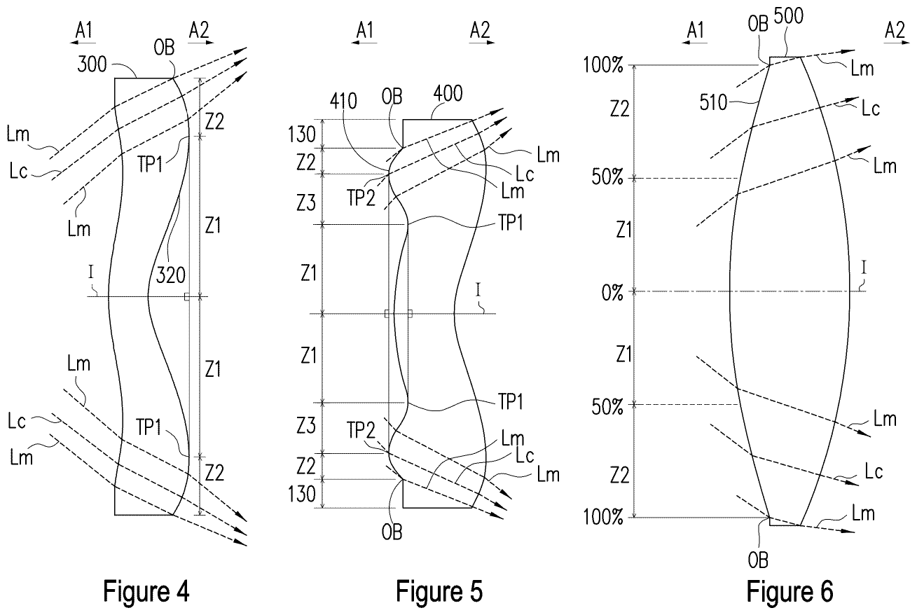

FIG. 2 is a radial cross-sectional view of a lens element 100. Two referential points for the surfaces of the lens element 100 can be defined: a central point and a transition point. The central point of a surface of a lens element is a point of intersection of that surface and the optical axis I. As illustrated in FIG. 2, a first central point CP1 may be present on the light output surface 110 of lens element 100 and a second central point CP2 may be present on the light input surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the light input side A2 of the lens element. The shape of a region is concave if the extension line of a collimated ray being parallel to the optical axis I and passing through the region intersects the optical axis I on the light output side A1 of the lens element.

Additionally, referring to FIG. 2, the lens element 100 may also have a mounting portion 130 extending radially outward from the optical boundary OB. The mounting portion 130 is typically used to physically secure the lens element to a corresponding element of the optical system (not shown). Rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 3, optical axis region Z1 is defined between central point CP and first transition point TP1. Periphery region Z2 is defined between TP1 and the optical boundary OB of the surface of the lens element. Collimated ray 211 intersects the optical axis Ion the light input side A2 of lens element 200 after passing through optical axis region Z1, i.e., the focal point of collimated ray 211 after passing through optical axis region Z1 is on the light input side A2 of the lens element 200 at point R in FIG. 3. Accordingly, since the ray itself intersects the optical axis I on the light input side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the light output side A1 of lens element 200, i.e., the focal point of collimated ray 212 after passing through periphery region Z2 is on the light output side A1 at point M in FIG. 3. Accordingly, since the extension line EL of the ray intersects the optical axis I on the light output side A1 of the lens element 200, periphery region Z2 is concave. In the lens element 200 illustrated in FIG. 3, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For a light output surface, a positive R value defines that the optical axis region of the light output surface is convex, and a negative R value defines that the optical axis region of the light output surface is concave. Conversely, for a light input surface, a positive R value defines that the optical axis region of the light input surface is concave, and a negative R value defines that the optical axis region of the light input surface is convex. The result found by using this method should be consistent with the method utilizing intersection of the optical axis by rays/extension lines mentioned above, which determines surface shape by referring to whether the focal point of a collimated ray being parallel to the optical axis I is on the light output side or the light input side of a lens element. As used herein, the terms “a shape of a region is convex (concave)”, “a region is convex (concave)”, and “a convex- (concave-) region”, can be used alternatively.

FIG. 4 to FIG. 6 illustrate examples of determining the shape of lens element regions and the boundaries of regions under various circumstances, including the optical axis region, the periphery region, and intermediate regions as set forth in the present specification.

FIG. 4 is a radial cross-sectional view of a lens element 300. As illustrated in FIG. 4, only one transition point TP1 appears within the optical boundary OB of the light input surface 320 of the lens element 300. Optical axis region Z1 and periphery region Z2 of the light input surface 320 of lens element 300 are illustrated in FIG. 4. The R value of the light input surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 4, since the shape of the optical axis region Z1 is concave, the shape of the periphery region Z2 will be convex as the shape changes at the transition point TP1.

FIG. 5 is a radial cross-sectional view of a lens element 400. Referring to FIG. 5, a first transition point TP1 and a second transition point TP2 are present on the light output surface 410 of lens element 400. The optical axis region Z1 of the light output surface 410 is defined between the optical axis I and the first transition point TP1. The R value of the light output surface 410 is positive (i.e., R>0). Accordingly, the optical axis region Z1 is convex.

The periphery region Z2 of the light output surface 410, which is also convex, is defined between the second transition point TP2 and the optical boundary OB of the light output surface 410 of the lens element 400. Further, intermediate region Z3 of the light output surface 410, which is concave, is defined between the first transition point TP1 and the second transition point TP2. Referring once again to FIG. 5, the light output surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the light output surface 410 of the lens element 400. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 6 is a radial cross-sectional view of a lens element 500. Lens element 500 has no transition point on the light output surface 510 of the lens element 500. For a surface of a lens element with no transition point, for example, the light output surface 510 the lens element 500, the optical axis region is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 6, the optical axis region Z1 of the light output surface 510 is defined between the optical axis I and 50% of the distance between the optical axis I and the optical boundary OB. The R value of the light output surface 510 is positive (i.e., R>0). Accordingly, the optical axis region Z1 is convex. For the light output surface 510 of the lens element 500, because there is no transition point, the periphery region Z2 of the light output surface 510 is also convex. It should be noted that lens element 500 may have a mounting portion (not shown) extending radially outward from the periphery region Z2.

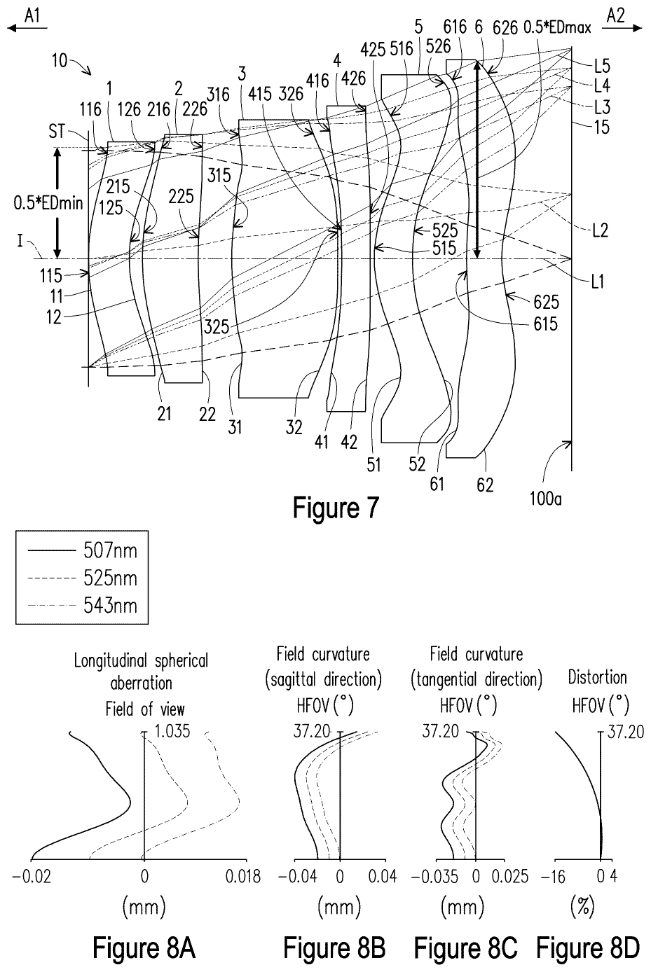

FIG. 7 is a schematic view of an optical lens assembly according to a first embodiment of the disclosure, and FIG. 8A to FIG. 8D are diagrams of longitudinal spherical aberration and various aberrations of the optical lens assembly according to the first embodiment. Please refer to FIG. 7 first. In the optical lens assembly 10 according to the first embodiment of the disclosure, from the light output side to the light input side along the optical axis I of the optical lens assembly 10, an aperture ST, a first lens element 1, a second lens element 2, a third lens element 3, a fourth lens element 4, a fifth lens element 5, and a sixth lens element 6 are sequentially included. When a beam L1, a beam L2, a beam L3, a beam L4, and a beam L5 emitted by the light emitting surface 100a of the multiple light source generating unit 15 enter the optical lens assembly 10, multiple beams are generated after sequentially passing through the sixth lens element 6, the fifth lens element 5, the fourth lens element 4, the third lens element 3, the second lens element 2, the first lens element 1, and the aperture ST and are projected out of the optical lens assembly 10. It is worth mentioning that the light input side A2 is a side facing the multiple light source generating unit 15, and the opposite side is the light output side A1. It is worth mentioning that in the optical lens assembly 10, lens elements having refracting power are only the above six lens elements, that is, the first lens element 1, the second lens element 2, the third lens element 3, the fourth lens element 4, the fifth lens element 5, and the sixth lens element 6. Also, materials of the first lens element 1, the second lens element 2, the third lens element 3, the fourth lens element 4, the fifth lens element 5, and the sixth lens element 6 may be plastic or glass.

On the other hand, the beam L1 and the beam L2 are beams emitted near a centroid (that is, a shape center) of the light emitting surface 100a and may be defined as central beams of the light emitting surface 100a. The beam L3, the beam L4, and the beam L5 are beams emitted at the edge of the light emitting surface 100a and may thus be defined as edge beams of the light emitting surface 100a.

In the embodiment, the first lens element 1, the second lens element 2, the third lens element 3, the fourth lens element 4, the fifth lens element 5, and the sixth lens element 6 of the optical lens assembly 10 respectively have a light output surface 11, a light output surface 21, a light output surface 31, a light output surface 41, a light output surface 51, and a light output surface 61 facing the light output side A1 and allowing the beam L1 to the beam L5 to pass through; and respectively have a light input surface 12, a light input surface 22, a light input surface 32, a light input surface 42, a light input surface 52, and a light input surface 62 facing the light input side A2 and allowing the beam L1 to the beam L5 to pass through.

The first lens element 1 is the sixth lens element having refracting power from the light input side A2 to the light output side A1. The first lens element 1 has negative refracting power. An optical axis region 115 and a periphery region 116 of the light output surface 11 of the first lens element 1 are both convex, and an optical axis region 125 and a periphery region 126 of the light input surface 12 of the first lens element 1 are both concave.

The second lens element 2 is the fifth lens element having refracting power from the light input side A2 to the light output side A1. The second lens element 2 has positive refracting power. An optical axis region 215 and a periphery region 216 of the light output surface 21 of the second lens element 2 are both convex, and an optical axis region 225 and a periphery region 226 of the light input surface 22 of the second lens element 2 are both concave.

The third lens element 3 is the fourth lens element having refracting power from the light input side A2 to the light output side A1. The third lens element 3 has positive refracting power. An optical axis region 315 of the light output surface 31 of the third lens element 3 is convex, and a periphery region 316 of the light output surface 31 is concave. An optical axis region 325 and a periphery region 326 of the light input surface 32 of the third lens element 3 are both convex.

The fourth lens element 4 is the third lens element having refracting power from the light input side A2 to the light output side A1. The fourth lens element 4 has negative refracting power. An optical axis region 415 and a periphery region 416 of the light output surface 41 of the fourth lens element 4 are both concave. An optical axis region 425 of the light input surface 42 of the fourth lens element 4 is concave, and a periphery region 426 of the light input surface 42 is convex.

The fifth lens element 5 is the second lens element having refracting power from the light input side A2 to the light output side A1. The fifth lens element 5 has positive refracting power. An optical axis region 515 of the light output surface 51 of the fifth lens element 5 is convex, and a periphery region 516 of the light output surface 51 is concave. An optical axis region 525 of the light input surface 52 of the fifth lens element 5 is concave, and a periphery region 526 of the light input surface 52 is convex.

The sixth lens element 6 is the first lens element having refracting power from the light input side A2 to the light output side A1. The sixth lens element 6 has negative refracting power. An optical axis region 615 of the light output surface 61 of the sixth lens element 6 is convex, and a periphery region 616 of the light output surface 31 is concave. An optical axis region 625 of the light input surface 62 of the sixth lens element 6 is concave, and a periphery region 626 is convex.

On the other hand, in the present embodiment and the embodiments described below, when the optical lens assembly 10 is adapted to a projection lens, the following conditional expression may also be satisfied: EDmax/EDmin≤2.100, where EDmax is the maximum effective diameter of the first lens element 1 to the sixth lens element 6. For example, in FIG. 7, in the vertical direction of the optical axis A of the optical lens assembly 10, the maximum effective diameter of a lens element (that is, a diameter of a surface shape in the lens element that may allow a beam to pass through) is the diameter of the light input surface 62 of the sixth lens element 6. Therefore, half of the maximum effective diameter, that is, 0.5*EDmax, is schematically drawn in FIG. 7. Similarly, EDmin is the minimum effective diameter of the first lens element 1 to the sixth lens element 6. For example, in FIG. 7, in the vertical direction of the optical axis I of the optical lens assembly 10, the minimum effective diameter of a lens element is the diameter of the light output surface 11 of the first lens element 1. Therefore, half of the minimum effective diameter, that is, 0.5*EDmin, is schematically drawn in FIG. 7. Therefore, when the optical lens assembly 10 is adapted to the projection lens, EDmax and EDmin may also respectively represent the maximum effective diameter and the minimum effective diameter of the projection lens.

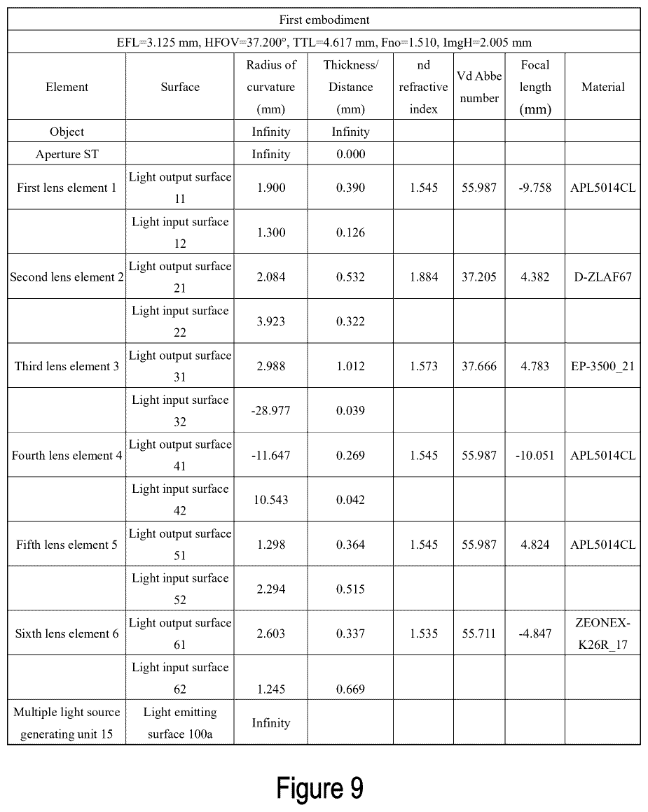

Other detailed optical data according to the first embodiment are shown in FIG. 9, and the effective focal length (EFL) of the overall system of the optical lens assembly 10 according to the first embodiment is 3.125 millimeters (mm), the half field of view (HFOV) is 37.200°, the F-number (Fno) is 1.510, and the system length (TTL) is 4.617 millimeters, wherein the system length refers to a distance from the light input surface 11 of the first lens element 1 to the light emitting surface 100a on the optical axis I. The “F-number” in the disclosure is the F-number calculated according to the principle of reversibility of light, by regarding the aperture ST as the entrance pupil. The image height (ImgH) is 2.005.

In addition, in the embodiment, the light output surfaces 11, 21, 31, 41, 51, and 61 and the light input surfaces 12, 22, 32, 42, 52, and 62 of the first lens element 1, the second lens element 2, the third lens element 3, the fourth lens element 4, the fifth lens element 5, and the sixth lens element 6, a total of 12 surfaces, are all aspheric surfaces, wherein the light output surfaces 11, 21, 31, 41, 51, and 61 and the light input surfaces 12, 22, 32, 42, 52, and 62 are general even aspheric surfaces. The aspheric surfaces are defined by the following equation:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i} \qquad ( 1 )$$

where,
Y: a distance between a point on an aspheric surface and the optical axis I;
Z: a depth of an aspheric surface (the perpendicular distance between a point on the aspheric surface with a distance Y from the optical axis I and the tangent to the vertex of the aspheric surface on the optical axis I);
R: a radius of curvature of a lens element surface near the optical axis I;
K: a conic constant; and
aᵢ: i-th order aspheric coefficient.

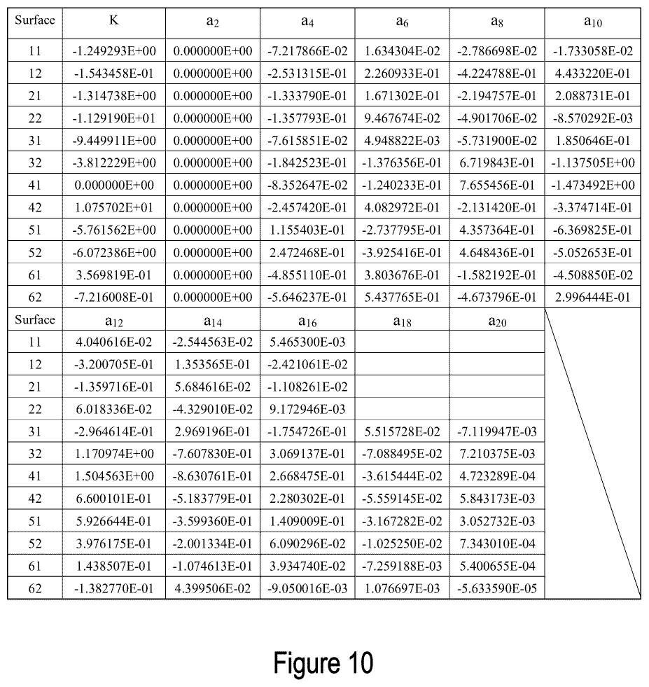

The various aspheric coefficients in Equation (1) from the light output surface 11 of the first lens element 1 to the light input surface 62 of the sixth lens element 6 are shown in FIG. 10. The field number 11 in FIG. 10 indicates the aspheric coefficient of the light output surface 11 of the first lens element 1, and other fields may be deduced by analogy.

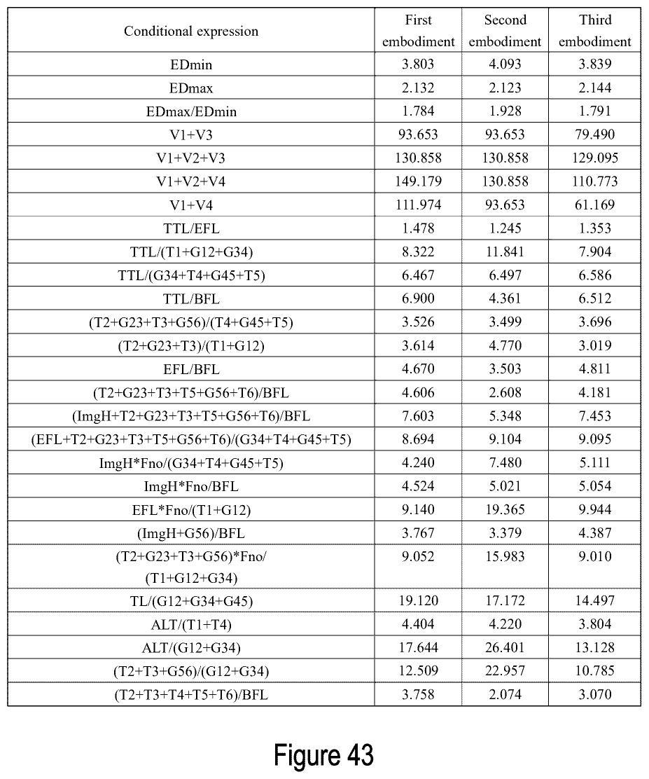

In addition, relationships between important parameters of the optical imaging lens 10 according to the first embodiment are shown in FIG. 43.
Where,
   T1 is the thickness of the first lens element 1 on the optical axis I;
   T2 is the thickness of the second lens element 2 on the optical axis I;
   T3 is the thickness of the third lens element 3 on the optical axis I;
   T4 is the thickness of the fourth lens element 4 on the optical axis I;
   T5 is the thickness of the fifth lens element 5 on the optical axis I;
   T6 is the thickness of the sixth lens element 6 on the optical axis I;
   G12 is the air gap between the first lens element 1 and the second lens element 2 on the optical axis I;
   G23 is the air gap between the second lens element 2 and the third lens element 3 on the optical axis I;
   G34 is the air gap between the third lens element 3 and the fourth lens element 4 on the optical axis I;
   G45 is the air gap between the fourth lens element 4 and the fifth lens element 5 on the optical axis I;
   G56 is the air gap between the fifth lens element 5 and the sixth lens element 6 on the optical axis I;
   AAG is the sum of the five air gaps from the first lens element 1 to the sixth lens element 6 on the optical axis I, that is, the sum of G12, G23, G34, G45, and G56;
   ALT is the sum of the six thicknesses from the first lens element 1 to the sixth lens element 6 on the optical axis I, that is, the sum of T1, T2, T3, T4, T5, and T6;
   TL is the distance from the light output surface 11 of the first lens element 1 to the light input surface 62 of the sixth lens element 6 on the optical axis I;
   TTL is the distance from the light output surface 11 of the first lens element 1 to the light emitting surface 100a on the optical axis I;
   BFL is the distance from the light input surface 62 of the sixth lens element 6 to the light emitting surface 100a on the optical axis I;
   LCR (light circle radius) is the radius of the light circle (labeled as LCR, as shown in FIG. 1B), is the radius of the minimum circumscribed circle of the light emitting surface 100a of the multiple light source generating unit 15, and is also the image height of the optical lens assembly;
   HFOV is the half field of view (labeled as ω, as shown in FIG. 1A) and is the maximum half light output angle of the optical lens assembly 10;
   Fno is an F-number, which is calculated based on the effective aperture of a beam emitted by the optical lens assembly 10 according to the principle of reversibility of light and is calculated by regarding the aperture ST as the entrance pupil in the embodiments of the disclosure;
   EFL is the effective focal length of the optical lens assembly 10.

In addition, it is defined that:
G6P is the air gap between the light input surface 62 of the sixth lens element 6 and the light emitting surface 100a on the optical axis I;
f1 is the focal length of the first lens element 1;
f2 is the focal length of the second lens element 2;
f3 is the focal length of the third lens element 3;
f4 is the focal length of the fourth lens element 4;
f5 is the focal length of the fifth lens element 5;
f6 is the focal length of the sixth lens element 6;
n1 is the nd refractive index of the first lens element 1;
n2 is the nd refractive index of the second lens element 2;
n3 is the nd refractive index of the third lens element 3;
n4 is the nd refractive index of the fourth lens element 4;
n5 is the nd refractive index of the fifth lens element 5;
n6 is the nd refractive index of the sixth lens element 6;
V1 is the Vd Abbe number of the first lens element 1;
V2 is the Vd Abbe number of the second lens element 2;
V3 is the Vd Abbe number of the third lens element 3;
V4 is the Vd Abbe number of the fourth lens element 4;
V5 is the Vd Abbe number of the fifth lens element 5; and
V6 is the Vd Abbe number of the sixth lens element 6.

It is worth mentioning that material parameters of lens elements disclosed in optical parameter tables of the disclosure adopt the formats of the nd refractive index and the Vd Abbe number of the international glass code, so that persons skilled in the art may know the specific material implementation, wherein nd is the refractive index of a substance at the d helium yellow line 587.56 nanometers (nm), and Vd is calculated based on the refractive indexes of the substance at the wavelengths of the Fraunhofer's d, F, and C spectral lines. The focal length value disclosed in the optical parameter tables of the embodiments is calculated based on the refractive index of the waveband implemented by the optical system, and the primary wavelength implemented in the embodiments of the disclosure is 525 nm, so the focal length value of the disclosure is calculated based on the refractive index of a material at 525 nm.

Also referring to FIG. 8A to FIG. 8D, the diagram of FIG. 8A illustrates the longitudinal spherical aberration according to the first embodiment, the diagrams of FIG. 8B and FIG. 8C respectively illustrate the field curvature aberration in the sagittal direction and the field curvature aberration in the tangential direction on a projection plane when the wavelengths thereof are 507 nm, 525 nm, and 543 nm according to the first embodiment, and the diagram of FIG. 8D illustrates the distortion aberration on the projection plane when the wavelengths thereof are 507 nm, 525 nm, and 543 nm according to the first embodiment.

In the longitudinal spherical aberration diagram according to the first embodiment in FIG. 8A, the curves formed by the wavelengths are all very close to and approaching the middle, which illustrates that off-axis rays with different heights of the wavelengths are all concentrated near imaging points. It can be seen from the skewness amplitudes of the curves of the wavelengths that the imaging point deviation of the off-axis rays with different heights is controlled within a range of ±0.02 mm. Therefore, the first embodiment does significantly improve the spherical aberration of the same wavelength. In addition, the distances between the three representative wavelengths are also fairly close, which represents that imaging positions of rays with different wavelengths are fairly concentrated, so that chromatic aberration is also significantly improved.

In the two field curvature aberration diagrams of FIG. 8B and FIG. 8C, the focal length variation of the three representative wavelengths within the entire field of view falls within ±0.04 mm, which illustrates that the optical lens assembly 10 according to the first embodiment may effectively eliminate aberration. The distortion aberration diagram of FIG. 8D shows that the distortion aberration according to the first embodiment is maintained within a range of ±16%, which illustrates that the distortion aberration according to the first embodiment meets the projection quality of the optical lens assembly 10. As such, compared with a conventional optical lens assembly, the first embodiment may still provide good imaging quality under the condition of the system length being shortened to about 4.617 mm. Therefore, the first embodiment may shorten the length of the projection lens and provide good projection image quality under the condition of maintaining good optical performance.

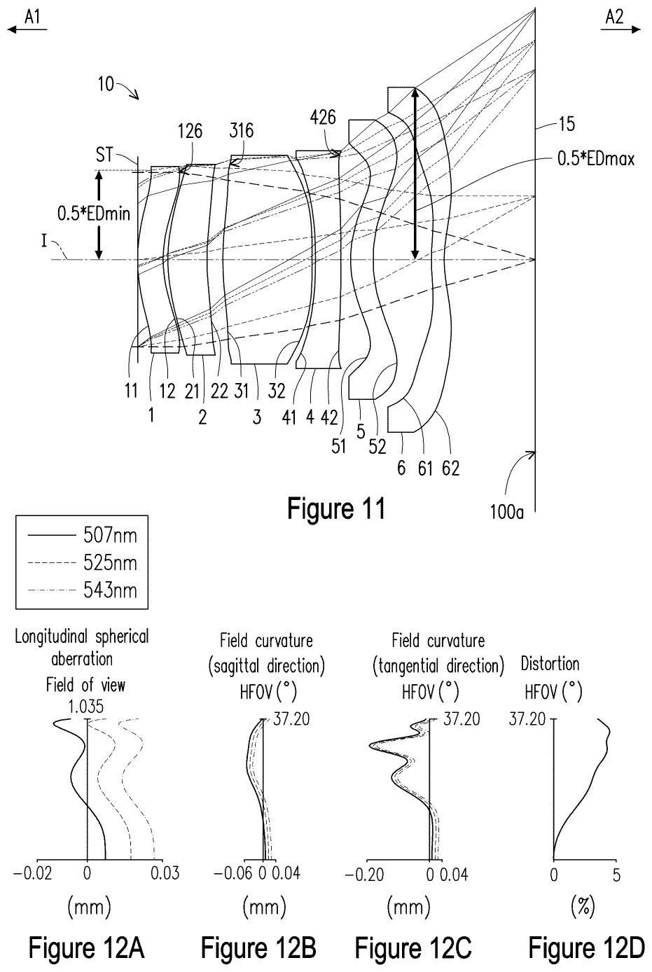

FIG. 11 is a schematic view of an optical lens assembly according to a second embodiment of the disclosure, and FIG. 12A to FIG. 12D are diagrams of longitudinal spherical aberration and various aberrations of the optical lens assembly according to the second embodiment. Please refer to FIG. 11 first. The optical lens assembly 10 according to the second embodiment of the disclosure is substantially similar to the first embodiment, and the differences between the two are as follows. Optical data, aspheric coefficients, and parameters of the first lens element 1, the second lens element 2, the third lens element 3, the fourth lens element 4, the fifth lens element 5, and the sixth lens element 6 are more or less different. In addition, in the embodiment, the periphery region 126 of the light input surface 12 of the first lens element 1 is convex; the periphery region 316 of the light output surface 31 of the third lens element 3 is convex; and the periphery region 426 of the light input surface 42 of the fourth lens element 4 is concave. It is particularly noted that in order to clearly show the drawing, numerals of some optical axis regions and periphery regions having similar surface shapes to those of the first embodiment are omitted in FIG. 11.

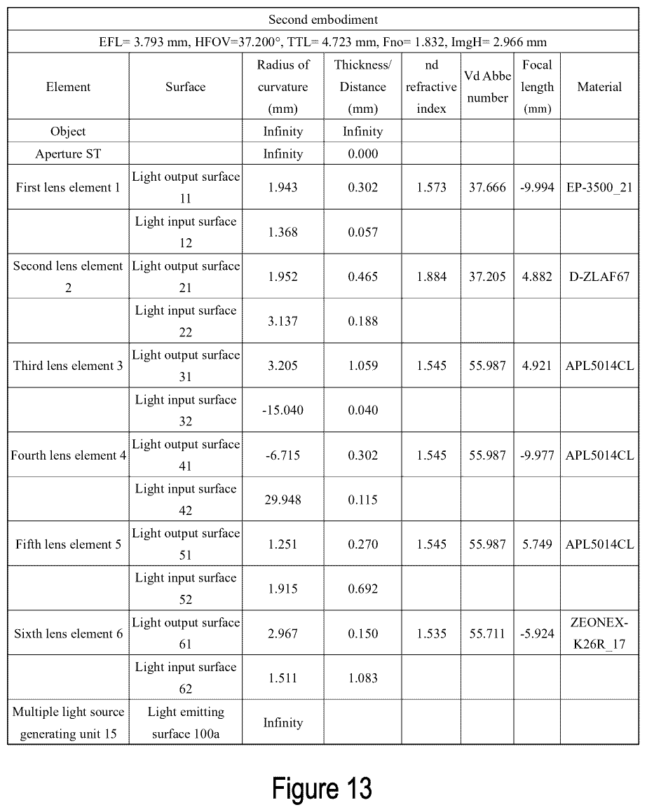

Detailed optical data of the optical imaging lens 10 according to the second embodiment are shown in FIG. 13, and the effective focal length of the optical imaging lens 10 according to the second embodiment is 3.793 mm, the half field of view (HFOV) is 37.200°, the F-number (Fno) is 1.832, the system length (TTL) is 4.723 mm, and the image height (ImgH) is 2.966 mm.

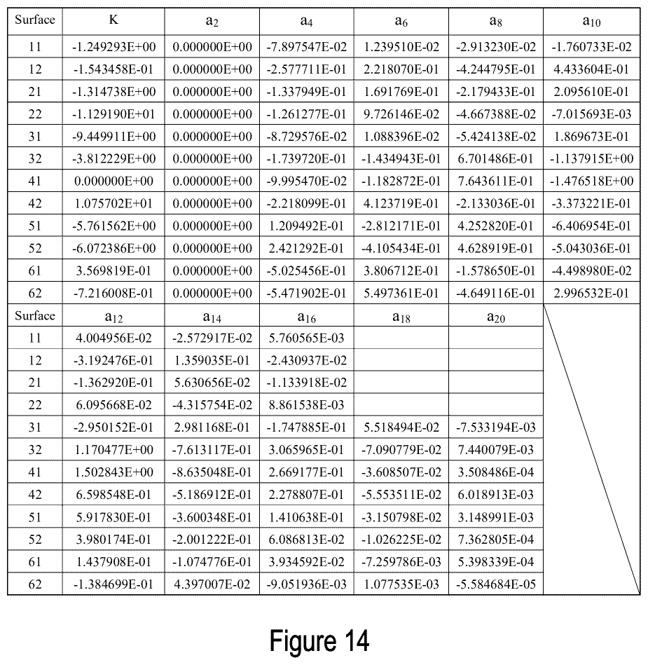

FIG. 14 shows aspheric coefficients of the light output surface 11 of the first lens element 1 to the light input surface 62 of the sixth lens element 6 in Equation (1) according to the second embodiment.

In addition, relationships between important parameters of the optical imaging lens 10 according to the second embodiment are shown in FIG. 43.

The longitudinal spherical aberration according to the second embodiment is shown in FIG. 12A, and the imaging point deviation of the off-axis rays with different heights is controlled within a range of ±0.03 mm. In the two field curvature aberration diagrams of FIG. 12B and FIG. 12C, the focal length variation of the three representative wavelengths within the entire field of view falls within ±0.2 mm. The distortion aberration diagram of FIG. 12D shows that the distortion aberration according to the second embodiment is maintained within a range of ±5%.

It can be seen from the above description that the distortion according to the second embodiment is better than the first embodiment. Also, the second embodiment also has a greater image height.

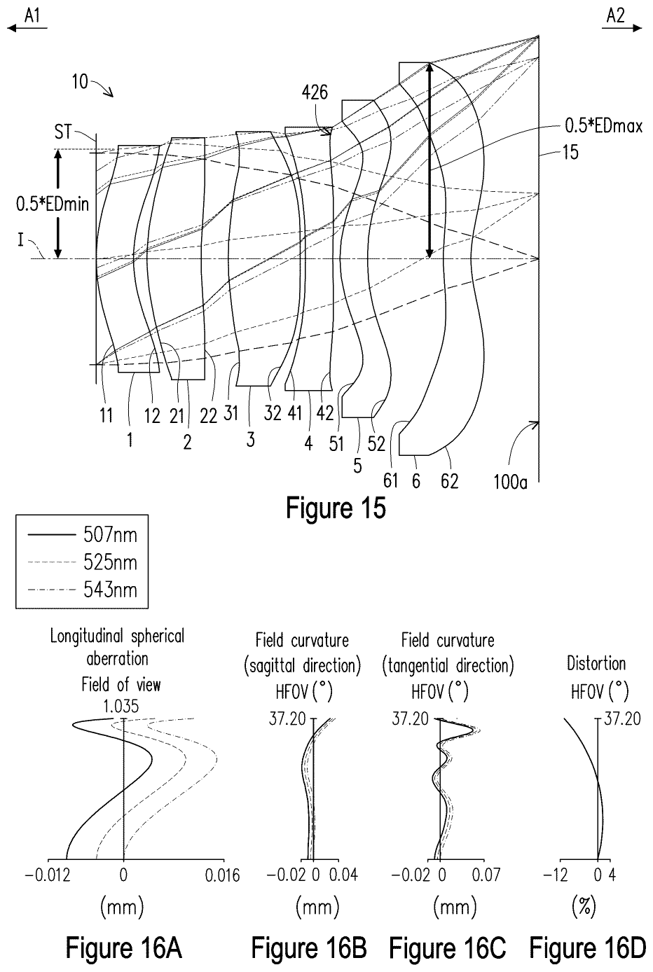

FIG. 15 is a schematic view of an optical lens assembly according to a third embodiment of the disclosure, and FIG. 16A to FIG. 16D are diagrams of longitudinal spherical aberration and various aberrations of the optical lens assembly according to the third embodiment. Please first refer to FIG. 15. The optical lens assembly 10 according to the third embodiment of the disclosure is substantially similar to the first embodiment, and the differences between the two are as follows. Optical data, aspheric coefficients, and parameters of the first lens element 1, the second lens element 2, the third lens element 3, the fourth lens element 4, the fifth lens element 5, and the sixth lens element 6 are more or less different. In addition, in the embodiment, the periphery region 426 of the light input surface 42 of the fourth lens element 4 is concave. It is particularly noted that in order to clearly show the drawing, numerals of some optical axis regions and periphery regions having similar surface shapes to those of the first embodiment are omitted in FIG. 15.

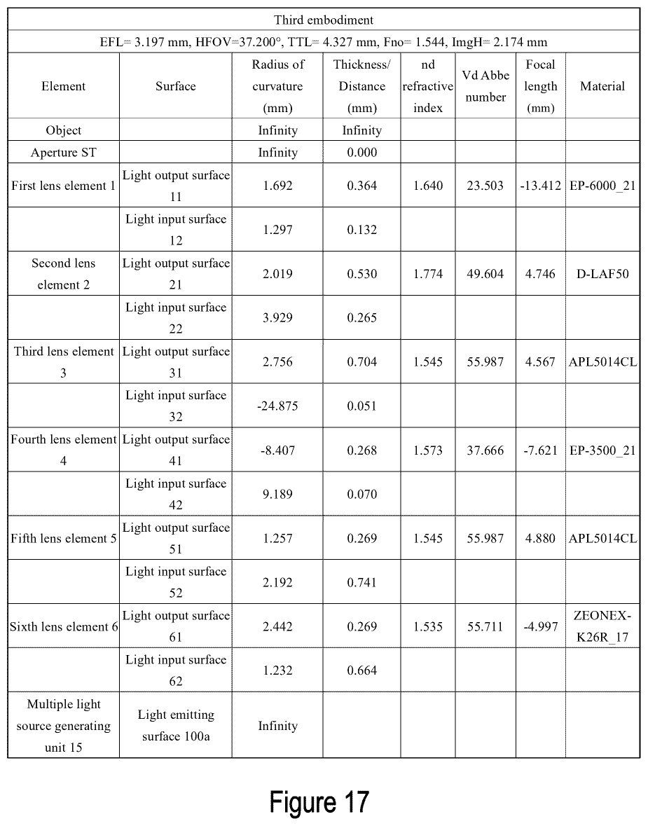

Detailed optical data of the optical imaging lens 10 according to the third embodiment are shown in FIG. 17, and the effective focal length of the optical imaging lens 10 according to the third embodiment is 3.197 mm, the half field of view (HFOV) is 37.200°, the F-number (Fno) is 1.544, the system length (TTL) is 4.327 mm, and the image height (ImgH) is 2.174 mm.

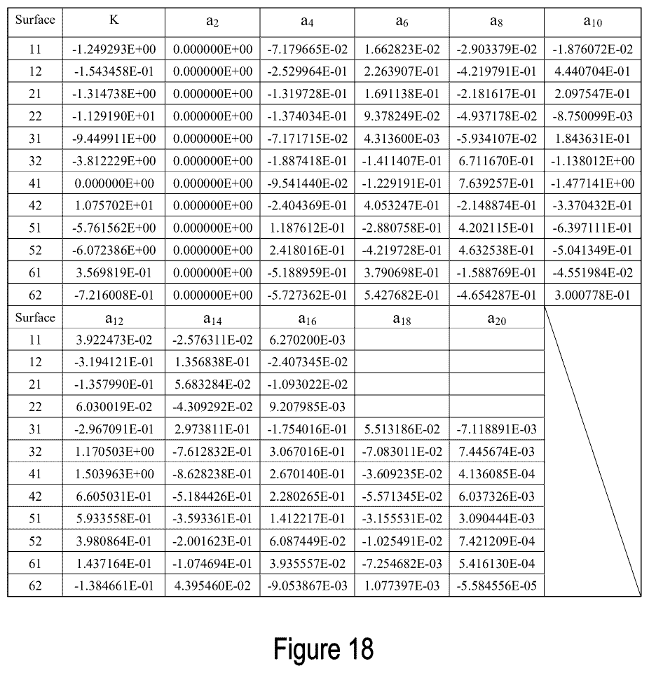

FIG. 18 shows aspheric coefficients of the light output surface 11 of the first lens element 1 to the light input surface 62 of the sixth lens element 6 in Equation (1) according to the third embodiment.

In addition, relationships between important parameters of the optical imaging lens 10 according to the third embodiment are shown in FIG. 43.

The longitudinal spherical aberration according to the third embodiment is shown in FIG. 16A, and the imaging point deviation of the off-axis rays with different heights is controlled within a range of ±0.016 mm. In the two field curvature aberration diagrams of FIG. 16B and FIG. 16C, the focal length variation of the three representative wavelengths within the entire field of view falls within ±0.07 mm. The distortion aberration diagram of FIG. 16D shows that the distortion aberration according to the third embodiment is maintained within a range of ±12%.

It can be seen from the above description that the system length according to the third embodiment is shorter than the first embodiment, the longitudinal spherical aberration and the distortion according to the third embodiment are better than the first embodiment, and the third embodiment also has a greater image height.

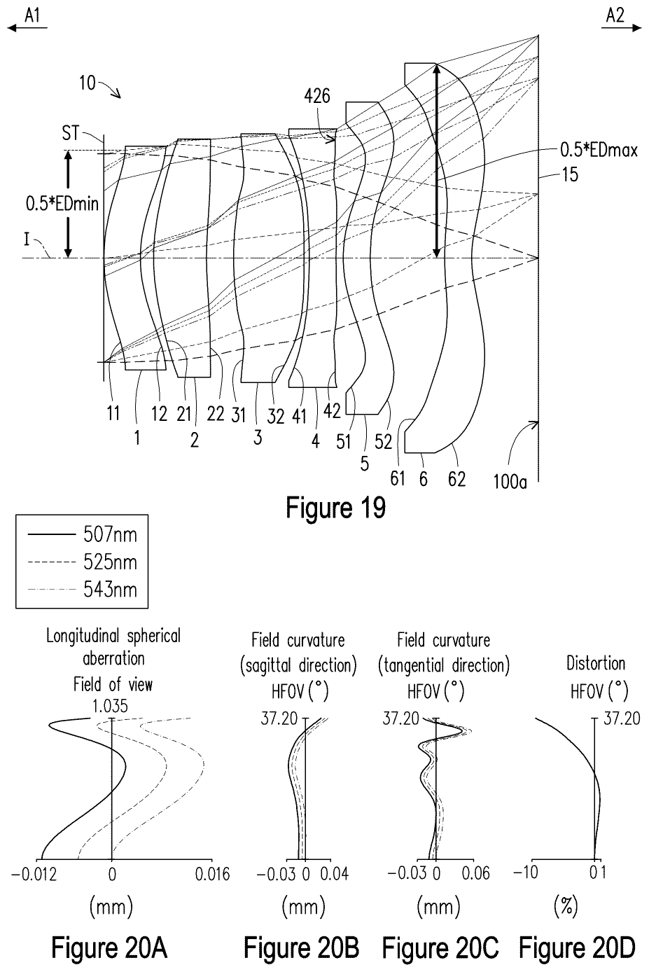

FIG. 19 is a schematic view of an optical lens assembly according to a fourth embodiment of the disclosure, and FIG. 20A to FIG. 20D are diagrams of longitudinal spherical aberration and various aberrations of the optical lens assembly according to the fourth embodiment. Please first refer to FIG. 19. The optical lens assembly 10 according to the fourth embodiment of the disclosure is substantially similar to the first embodiment, and the differences between the two are as follows. Optical data, aspheric coefficients, and parameters of the first lens element 1, the second lens element 2, the third lens element 3, the fourth lens element 4, the fifth lens element 5, and the sixth lens element 6 are more or less different. In addition, in the embodiment, the periphery region 426 of the light input surface 42 of the fourth lens element 4 is concave. It is particularly noted that in order to clearly show the drawing, numerals of some optical axis regions and periphery regions having similar surface shapes to those of the first embodiment are omitted in FIG. 19.

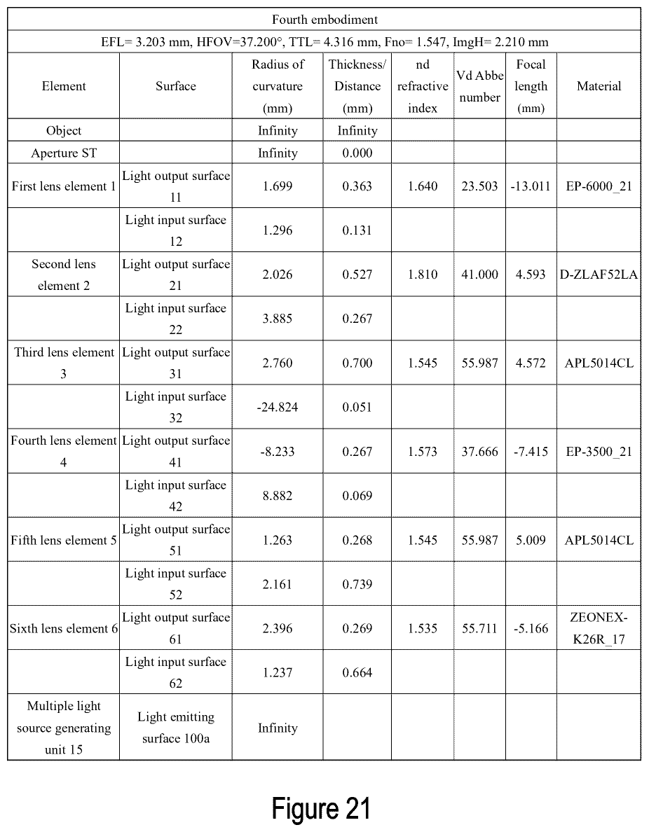

Detailed optical data of the optical imaging lens 10 according to the fourth embodiment are shown in FIG. 21, and the effective focal length of the optical imaging lens 10 according to the fourth embodiment is 3.203 mm, the half field of view (HFOV) is 37.200°, the F-number (Fno) is 1.547, the system length (TTL) is 4.316 mm, and the image height (ImgH) is 2.210 mm.

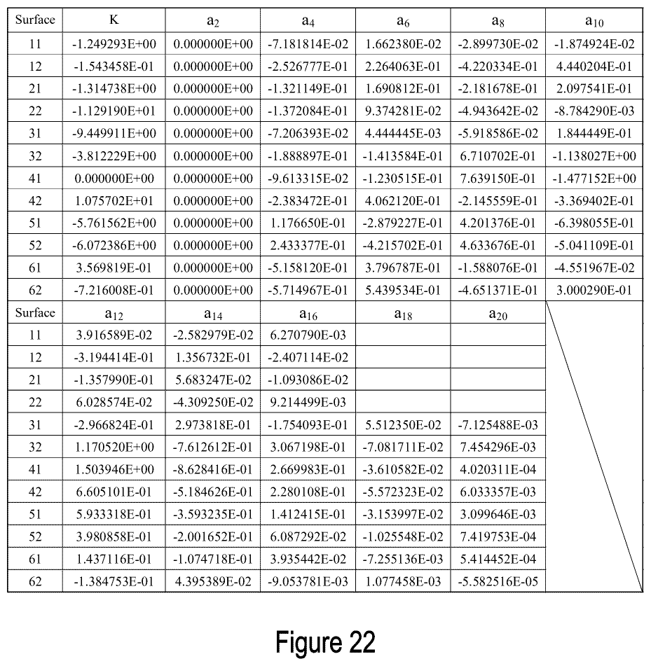

FIG. 22 shows aspheric coefficients of the light output surface 11 of the first lens element 1 to the light input surface 62 of the sixth lens element 6 in Equation (1) according to the fourth embodiment.

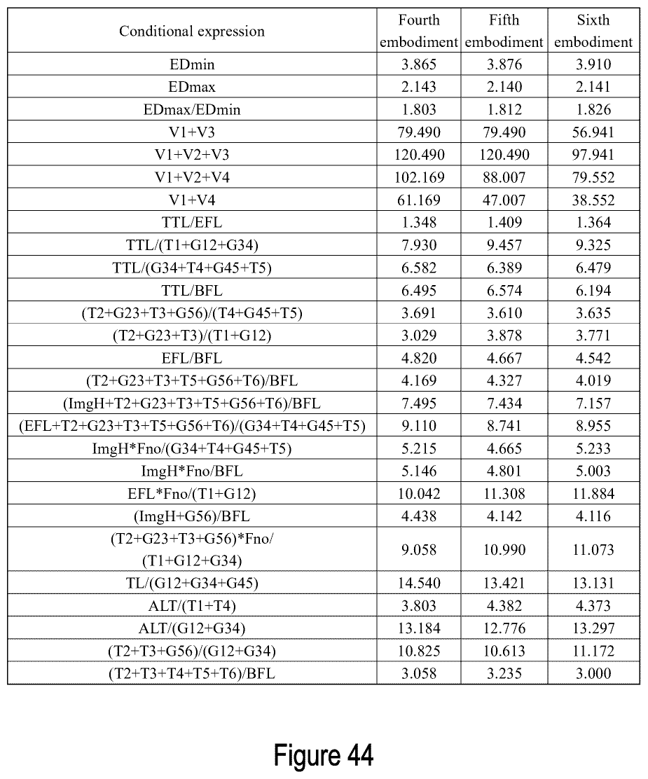

In addition, relationships between important parameters of the optical imaging lens 10 according to the fourth embodiment are shown in FIG. 44.

The longitudinal spherical aberration according to the fourth embodiment is shown in FIG. 20A, and the imaging point deviation of the off-axis rays with different heights is controlled within a range of ±0.016 mm. In the two field curvature aberration diagrams of FIG. 20B and FIG. 20C, the focal length variation of the three representative wavelengths within the entire field of view falls within ±0.06 mm. The distortion aberration diagram of FIG. 20D shows that the distortion aberration according to the fourth embodiment is maintained within a range of ±10%.

It can be seen from the above description that the system length according to the fourth embodiment is shorter than the first embodiment, and the longitudinal spherical aberration and the distortion according to the fourth embodiment are better than the first embodiment. Also, the fourth embodiment also has a greater image height.

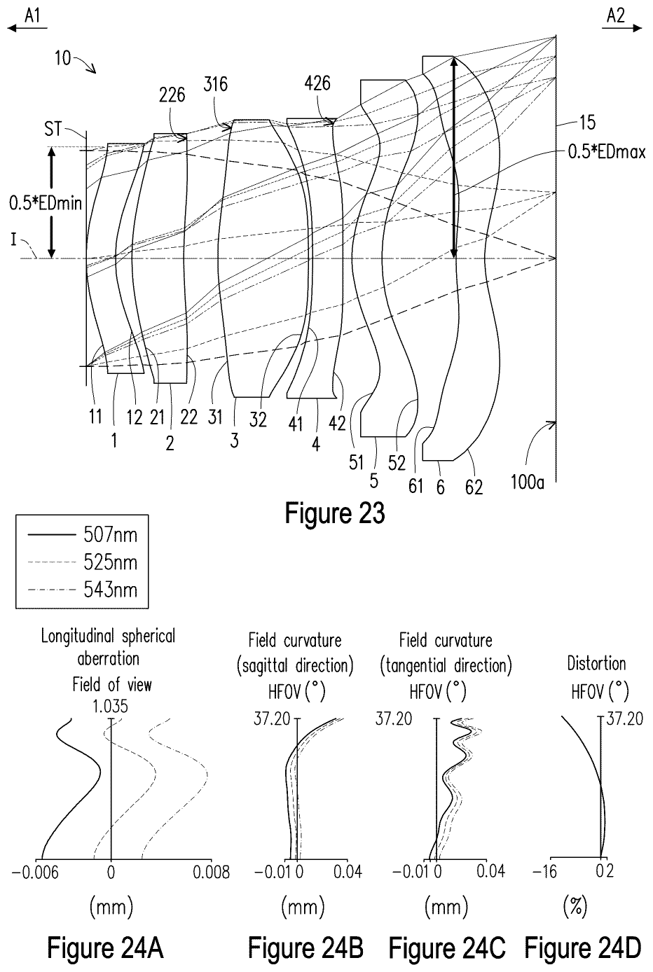

FIG. 23 is a schematic view of an optical lens assembly according to a fifth embodiment of the disclosure, and FIG. 24A to FIG. 24D are diagrams of longitudinal spherical aberration and various aberrations of the optical lens assembly according to the fifth embodiment. Please first refer to FIG. 23. The optical lens assembly 10 according to the fifth embodiment of the disclosure is substantially similar to the first embodiment, and the differences between the two are as follows. Optical data, aspheric coefficients, and parameters of the first lens element 1, the second lens element 2, the third lens element 3, the fourth lens element 4, the fifth lens element 5, and the sixth lens element 6 are more or less different. In addition, in the embodiment, the periphery region 226 of the light input surface 22 of the second lens element 2 is convex. The periphery region 316 of the light output surface 31 of the third lens element 3 is convex. The periphery region 426 of the light input surface 42 of the fourth lens element 4 is concave. It is particularly noted that in order to clearly show the drawing, numerals of some optical axis regions and periphery regions having similar surface shapes to those of the first embodiment are omitted in FIG. 23.

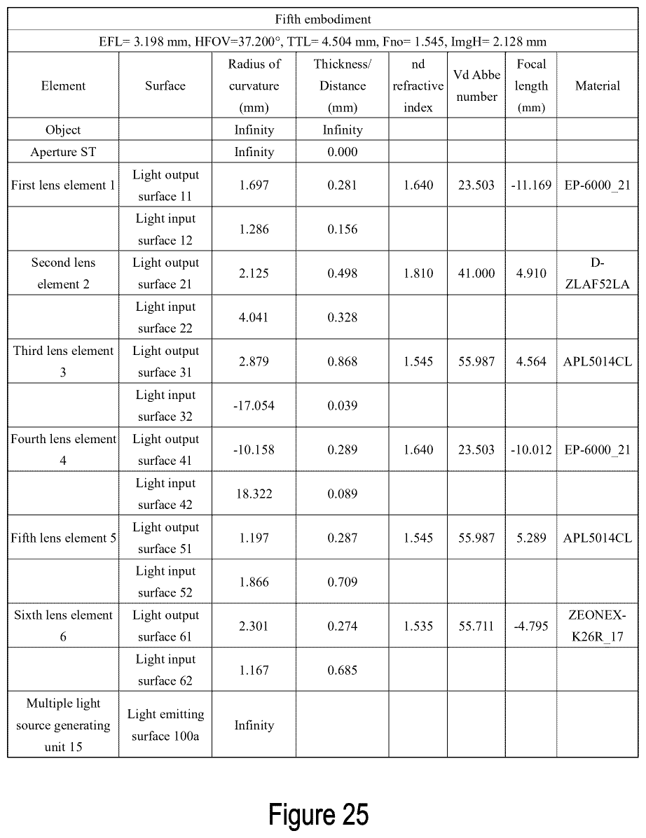

Detailed optical data of the optical imaging lens 10 according to the fifth embodiment are shown in FIG. 25, and the effective focal length of the optical imaging lens 10 according to the fifth embodiment is 3.198 mm, the half field of view (HFOV) is 37.200°, the F-number (Fno) is 1.545, the system length (TTL) is 4.504 mm, and the image height (ImgH) is 2.128 mm.

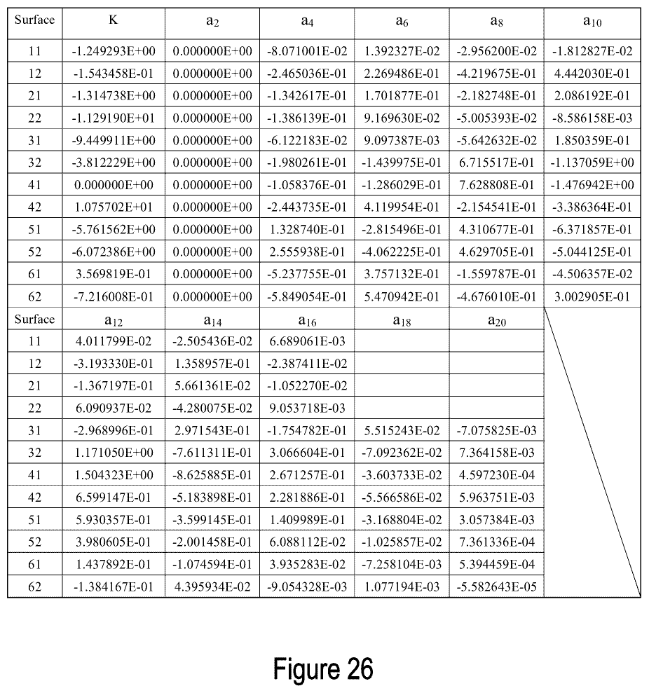

FIG. 26 shows aspheric coefficients of the light output surface 11 of the first lens element 1 to the light input surface 62 of the sixth lens element 6 in Equation (1) according to the fifth embodiment.

In addition, relationships between important parameters of the optical imaging lens 10 according to the fifth embodiment are shown in FIG. 44.

The longitudinal spherical aberration according to the fifth embodiment is shown in FIG. 24A, and the imaging point deviation of the off-axis rays with different heights is controlled within a range of ±0.008 mm. In the two field curvature aberration diagrams of FIG. 24B and FIG. 24C, the focal length variation of the three representative wavelengths within the entire field of view falls within ±0.04 mm. The distortion aberration diagram of FIG. 24D shows that the distortion aberration according to the fifth embodiment is maintained within a range of ±16%.

It can be seen from the above description that the system length according to the fifth embodiment is shorter than the first embodiment, and the longitudinal spherical aberration and the distortion according to the fifth embodiment are better than the first embodiment. Also, the fifth embodiment also has a greater image height.

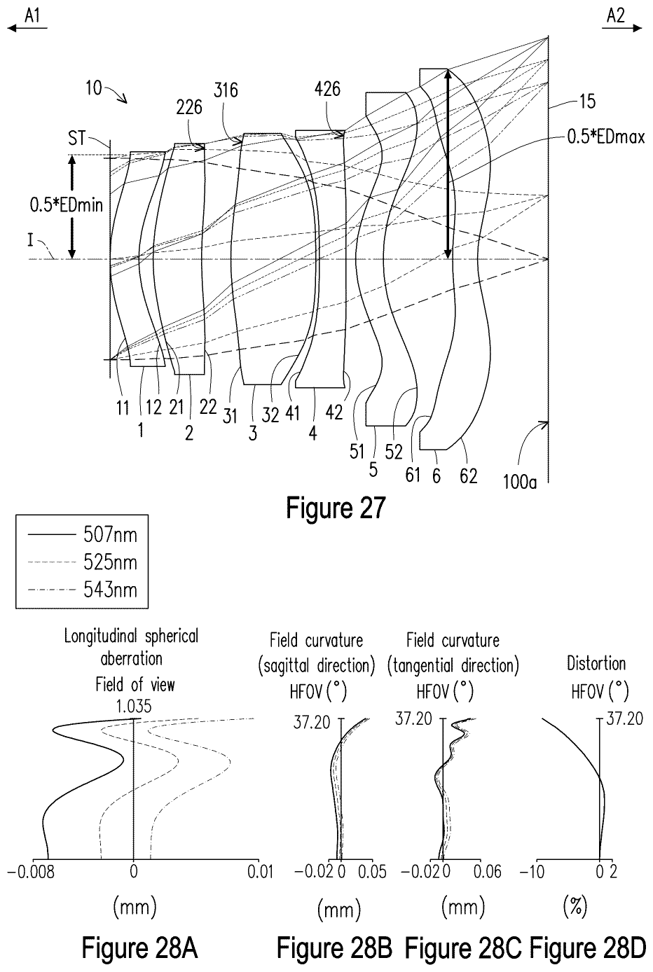

FIG. 27 is a schematic view of an optical lens assembly according to a sixth embodiment of the disclosure, and FIG. 28A to FIG. 28D are diagrams of longitudinal spherical aberration and various aberrations of the optical lens assembly according to the sixth embodiment. Please first refer to FIG. 27. The optical lens assembly 10 according to the sixth embodiment of the disclosure is substantially similar to the first embodiment, and the differences between the two are as follows. Optical data, aspheric coefficients, and parameters of the first lens element 1, the second lens element 2, the third lens element 3, the fourth lens element 4, the fifth lens element 5, and the sixth lens element 6 are more or less different. In addition, in the embodiment, the periphery region 226 of the light input surface 22 of the second lens element 2 is convex. The periphery region 316 of the light output surface 31 of the third lens element 3 is convex. The periphery region 426 of the light input surface 42 of the fourth lens element 4 is concave. It is particularly noted that in order to clearly show the drawing, numerals of some optical axis regions and periphery regions having similar surface shapes to those of the first embodiment are omitted in FIG. 27.

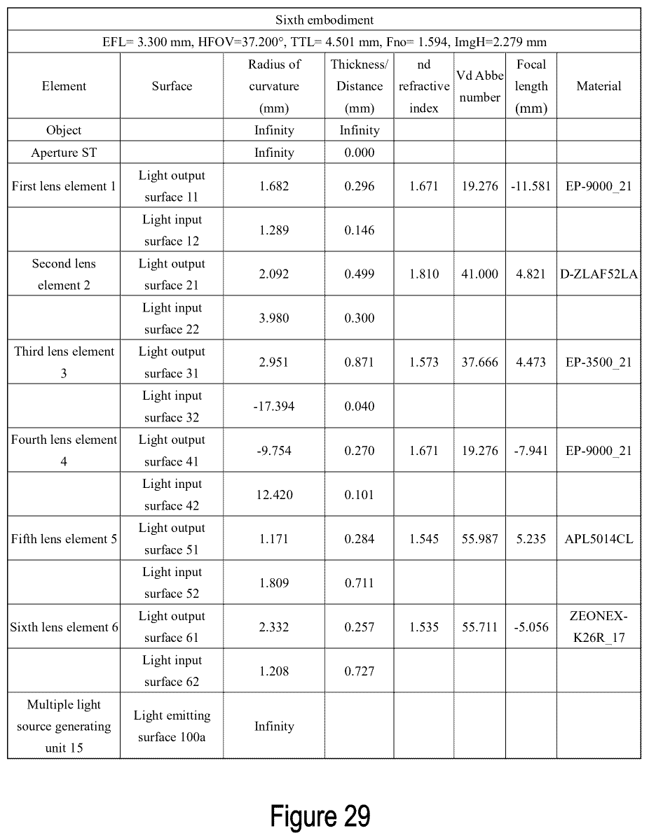

Detailed optical data of the optical imaging lens 10 according to the sixth embodiment are shown in FIG. 29, and the effective focal length of the optical imaging lens 10 according to the sixth embodiment is 3.300 mm, the half field of view (HFOV) is 37.200°, the F-number (Fno) is 1.594, the system length (TTL) is 4.501 mm, and the image height (ImgH) is 2.279 mm.

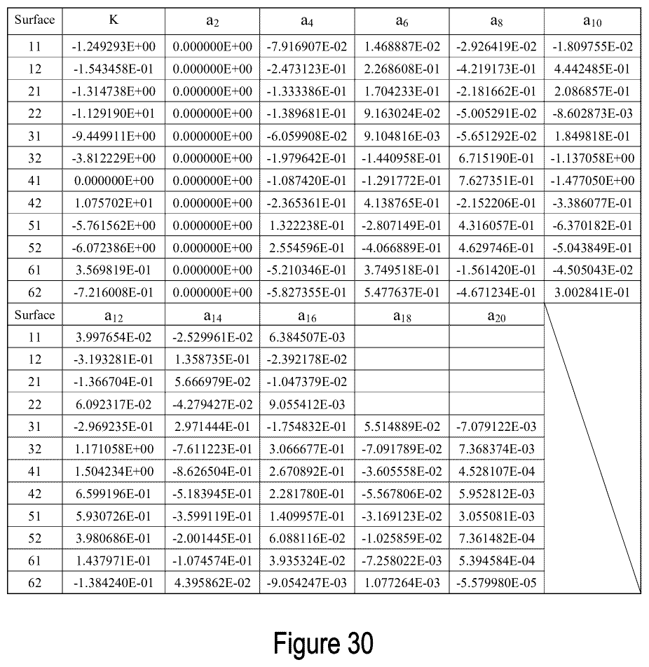

FIG. 30 shows aspheric coefficients of the light output surface 11 of the first lens element 1 to the light input surface 62 of the sixth lens element 6 in Equation (1) according to the sixth embodiment.

In addition, relationships between important parameters of the optical imaging lens 10 according to the sixth embodiment are shown in FIG. 44.

The longitudinal spherical aberration according to the sixth embodiment is shown in FIG. 28A, and the imaging point deviation of the off-axis rays with different heights is controlled within a range of ±0.01 mm. In the two field curvature aberration diagrams of FIG. 28B and FIG. 28C, the focal length variation of the three representative wavelengths within the entire field of view falls within ±0.06 mm. The distortion aberration diagram of FIG. 28D shows that the distortion aberration according to the sixth embodiment is maintained within a range of ±10%.

It can be seen from the above description that the system length according to the sixth embodiment is shorter than the first embodiment, and the longitudinal spherical aberration and the distortion according to the sixth embodiment are better than the first embodiment. Also, the sixth embodiment also has a greater image height.

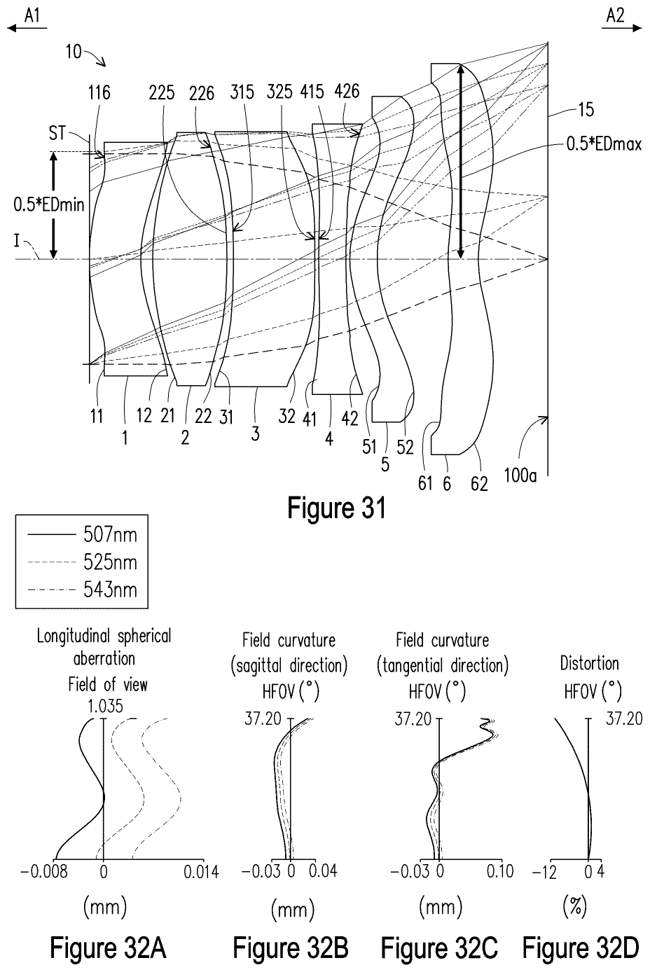

FIG. 31 is a schematic view of an optical lens assembly according to a seventh embodiment of the disclosure, and FIG. 32A to FIG. 32D are diagrams of longitudinal spherical aberration and various aberrations of the optical lens assembly according to the seventh embodiment. Please first refer to FIG. 31. The optical lens assembly 10 according to the seventh embodiment of the disclosure is substantially similar to the first embodiment, and the differences between the two are as follows. Optical data, aspheric coefficients, and parameters of the first lens element 1, the second lens element 2, the third lens element 3, the fourth lens element 4, the fifth lens element 5, and the sixth lens element 6 are more or less different. In addition, in the embodiment, the periphery region 116 of the light output surface 11 of the first lens element 1 is concave. The optical axis region 225 and the periphery region 226 of the light input surface 22 of the second lens element 2 are both convex. The third lens element 3 has negative refracting power, the optical axis region 315 of the light output surface 31 of the third lens element 3 is concave, and the optical axis region 325 of the light input surface 32 of the third lens element 3 is concave. The optical axis region 415 of the light output surface 41 of the fourth lens element 4 is convex, and the periphery region 426 of the light input surface 42 of the fourth lens element 4 is concave. It is particularly noted that in order to clearly show the drawing, numerals of some optical axis regions and periphery regions having similar surface shapes to those of the first embodiment are omitted in FIG. 31.

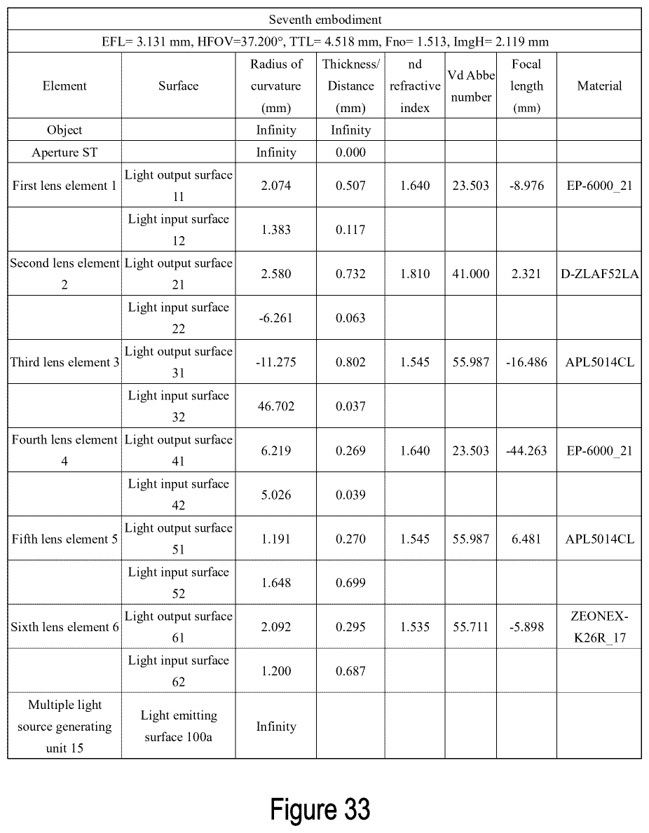

Detailed optical data of the optical imaging lens 10 according to the seventh embodiment are shown in FIG. 33, and the effective focal length of the optical imaging lens 10 according to the seventh embodiment is 3.131 mm, the half field of view (HFOV) is 37.200°, the F-number (Fno) is 1.513, the system length (TTL) is 4.518 mm, and the image height (ImgH) is 2.119 mm.

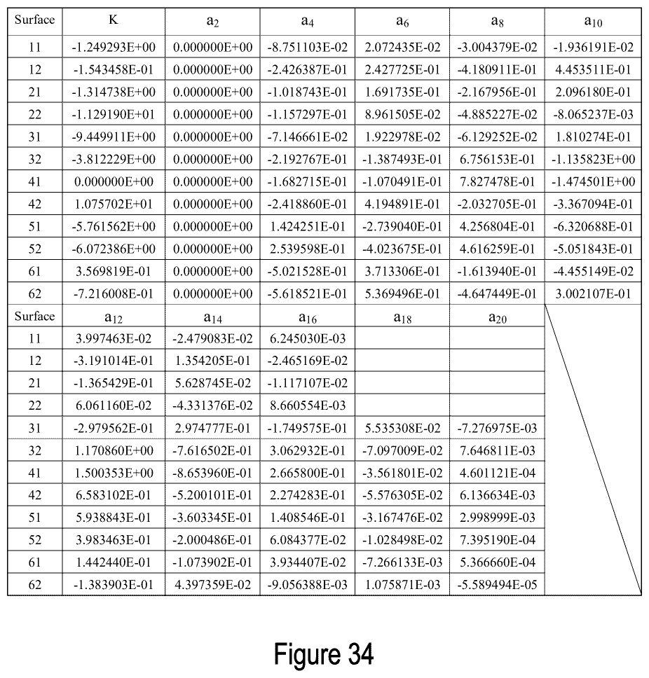

FIG. 34 shows aspheric coefficients of the light output surface 11 of the first lens element 1 to the light input surface 62 of the sixth lens element 6 in Equation (1) according to the seventh embodiment.

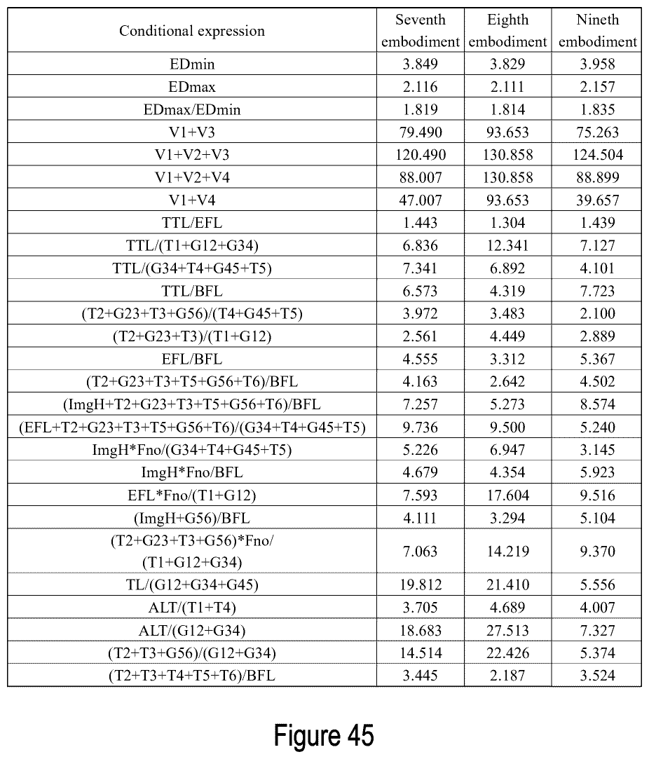

In addition, relationships between important parameters of the optical imaging lens 10 according to the seventh embodiment are shown in FIG. 45.

The longitudinal spherical aberration according to the seventh embodiment is shown in FIG. 32A, and the imaging point deviation of the off-axis rays with different heights is controlled within a range of ±0.014 mm. In the two field curvature aberration diagrams of FIG. 32B and FIG. 32C, the focal length variation of the three representative wavelengths within the entire field of view falls within ±0.10 mm. The distortion aberration diagram of FIG. 32D shows that the distortion aberration according to the seventh embodiment is maintained within a range of ±12%.

It can be seen from the above description that the system length according to the seventh embodiment is shorter than the first embodiment, and the longitudinal spherical aberration and the distortion according to the seventh embodiment are better than the first embodiment. Also, the seventh embodiment also has a greater image height.

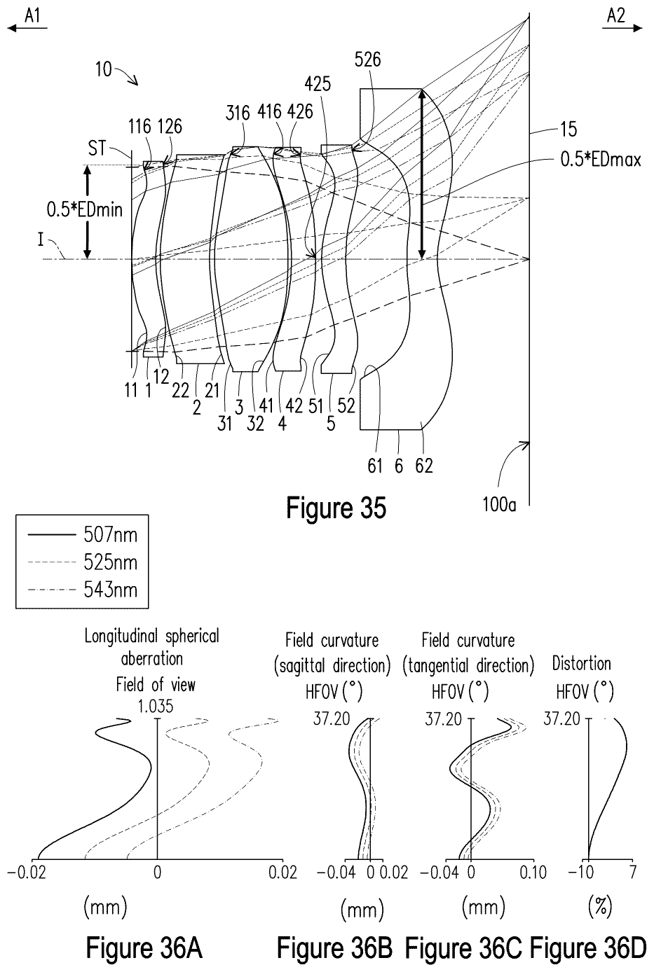

FIG. 35 is a schematic view of an optical lens assembly according to an eighth embodiment of the disclosure, and FIG. 36A to FIG. 36D are diagrams of longitudinal spherical aberration and various aberrations of the optical lens assembly according to the eighth embodiment. Please first refer to FIG. 35. The optical lens assembly 10 according to the eighth embodiment of the disclosure is substantially similar to the first embodiment, and the differences between the two are as follows. Optical data, aspheric coefficients, and parameters of the first lens element 1, the second lens element 2, the third lens element 3, the fourth lens element 4, the fifth lens element 5, and the sixth lens element 6 are more or less different. In addition, in the embodiment, the periphery region 116 of the light output surface 11 of the first lens element 1 is concave, and the periphery region 126 of the light input surface 12 is convex. The periphery region 316 of the light output surface 31 of the third lens element 3 is convex. The periphery region 416 of the light output surface 41 of the fourth lens element 4 is convex, the optical axis region 425 of the light input surface 42 of the fourth lens element 4 is convex, and the periphery region 426 of the light input surface 42 is concave. The periphery region 526 of the light input surface 52 of the fifth lens element 5 is concave. It is particularly noted that in order to clearly show the drawing, numerals of some optical axis regions and periphery regions having similar surface shapes to those of the first embodiment are omitted in FIG. 35.

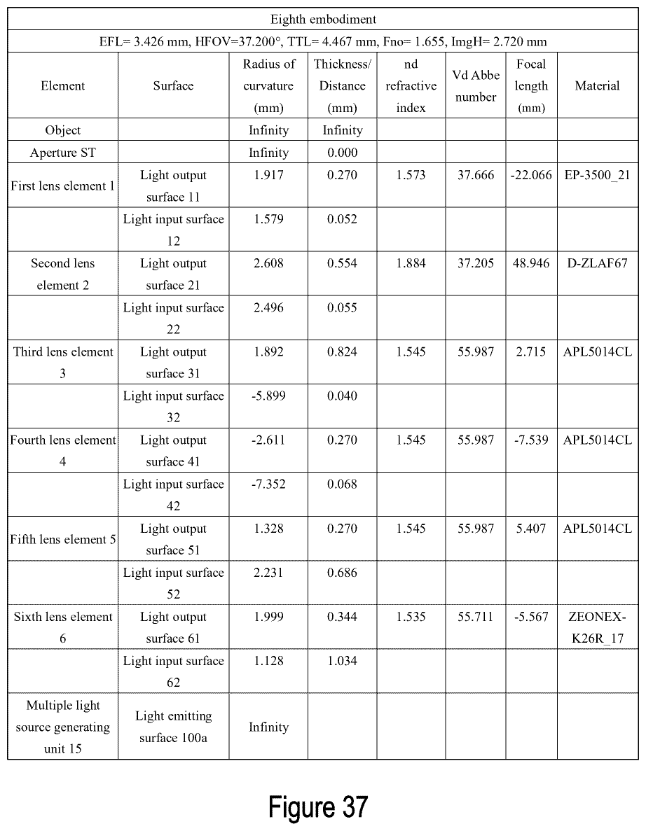

Detailed optical data of the optical imaging lens 10 according to the eighth embodiment are shown in FIG. 37, and the effective focal length of the optical imaging lens 10 according to the eighth embodiment is 3.426 mm, the half field of view (HFOV) is 37.200°, the F-number (Fno) is 1.655, the system length (TTL) is 4.467 mm, and the image height (ImgH) is 2.720 mm.

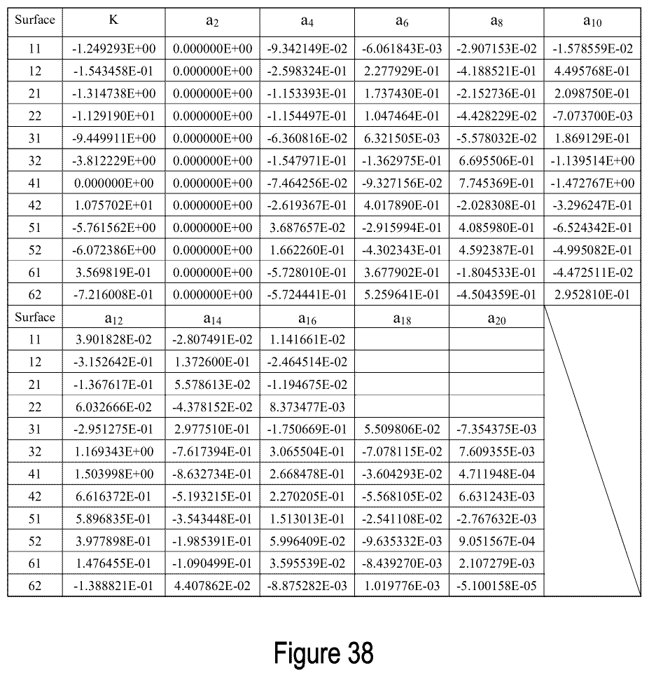

FIG. 38 shows aspheric coefficients of the light output surface 11 of the first lens element 1 to the light input surface 62 of the sixth lens element 6 in Equation (1) according to the eighth embodiment.

In addition, relationships between important parameters of the optical imaging lens 10 according to the eighth embodiment are shown in FIG. 45.

The longitudinal spherical aberration according to the eighth embodiment is shown in FIG. 36A, and the imaging point deviation of the off-axis rays with different heights is controlled within a range of ±0.02 mm. In the two field curvature aberration diagrams of FIG. 36B and FIG. 36C, the focal length variation of the three representative wavelengths within the entire field of view falls within ±0.10 mm. The distortion aberration diagram of FIG. 36D shows that the distortion aberration according to the eighth embodiment is maintained within a range of ±7%.

It can be seen from the above description that the system length according to the eighth embodiment is shorter than the first embodiment, and the distortion according to the eighth embodiment is better than the first embodiment. Also, the eighth embodiment also has a greater image height.

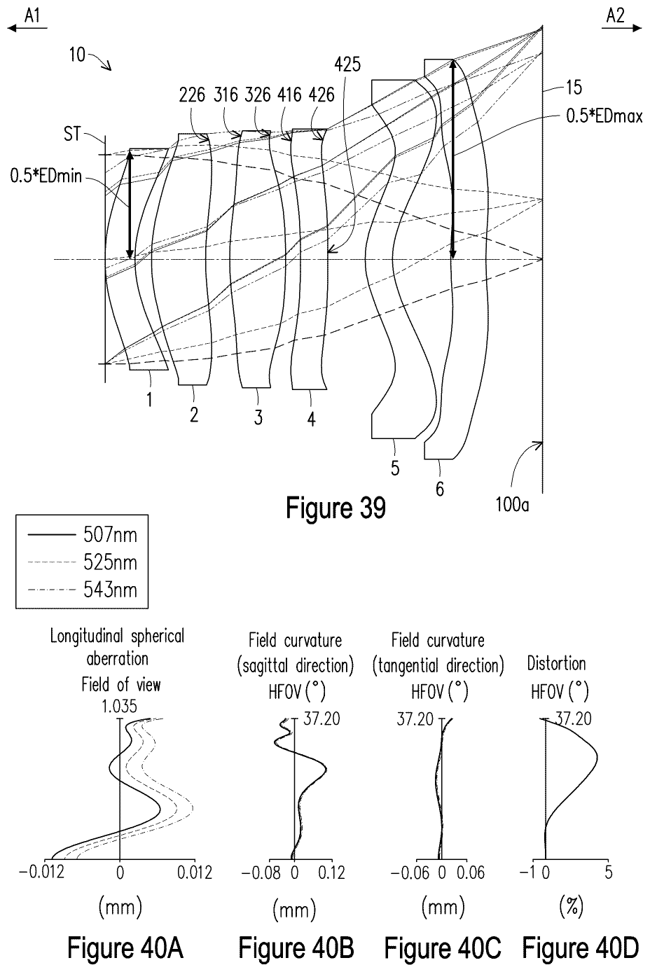

FIG. 39 is a schematic view of an optical lens assembly according to a nineth embodiment of the disclosure, and FIG. 40A to FIG. 40D are diagrams of longitudinal spherical aberration and various aberrations of the optical lens assembly according to the nineth embodiment. Please first refer to FIG. 39. The optical lens assembly 10 according to the nineth embodiment of the disclosure is substantially similar to the first embodiment, and the differences between the two are as follows. Optical data, aspheric coefficients, and parameters of the first lens element 1, the second lens element 2, the third lens element 3, the fourth lens element 4, the fifth lens element 5, and the sixth lens element 6 are more or less different. In addition, in the embodiment, the periphery region 226 of the light input surface 22 of the second lens element 2 is convex. The periphery region 316 of the light output surface 31 of the third lens element 3 is convex, and the periphery region 326 of the light input surface 32 of the third lens element 3 is concave. The periphery region 416 of the light output surface 41 of the fourth lens element 4 is convex, the optical axis region 425 of the light input surface 42 of the fourth lens element 4 is convex, and the periphery region 426 of the light input surface 42 is concave. The sixth lens element 6 has positive refracting power. It is particularly noted that in order to clearly show the drawing, numerals of some optical axis regions and periphery regions having similar surface shapes to those of the first embodiment are omitted in FIG. 39.

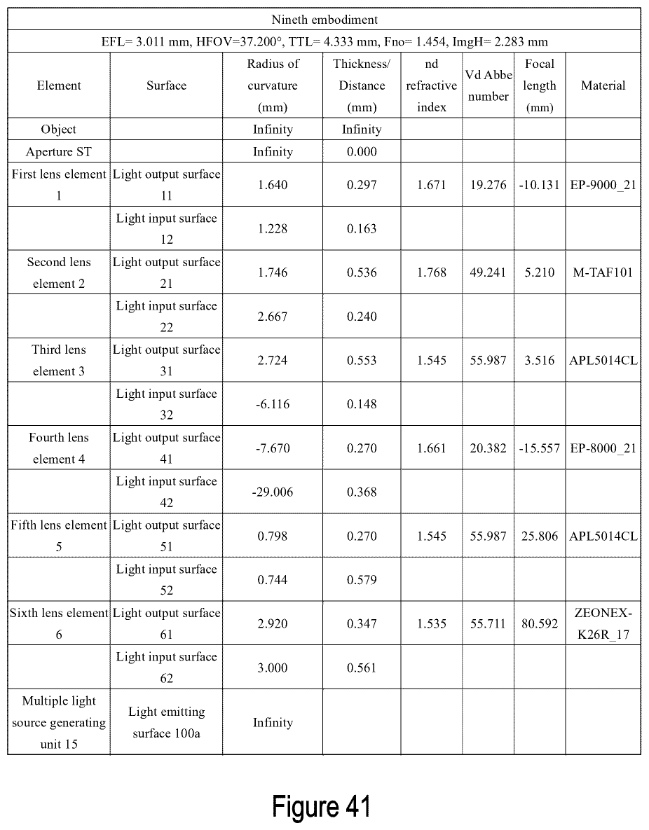

Detailed optical data of the optical imaging lens 10 according to the nineth embodiment are shown in FIG. 41, and the effective focal length of the optical imaging lens 10 according to the nineth embodiment is 3.011 mm, the half field of view (HFOV) is 37.200°, the F-number (Fno) is 1.454, the system length (TTL) is 4.333 mm, and the image height (ImgH) is 2.283 mm.

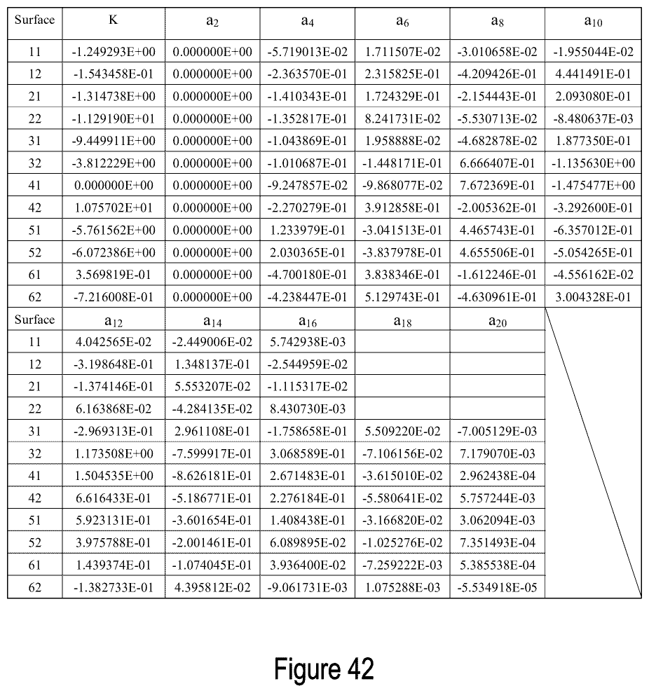

FIG. 42 shows aspheric coefficients of the light output surface 11 of the first lens element 1 to the light input surface 62 of the sixth lens element 6 in Equation (1) according to the nineth embodiment.

In addition, relationships between important parameters of the optical imaging lens 10 of the nineth embodiment are shown in FIG. 45.

The longitudinal spherical aberration according to the nineth embodiment is shown in FIG. 40A, and the imaging point deviation of the off-axis rays with different heights is controlled within a range of ±0.012 mm. In the two field curvature aberration diagrams of FIG. 40B and FIG. 40C, the focal length variation of the three representative wavelengths within the entire field of view falls within ±0.12 mm. The distortion aberration diagram of FIG. 40D shows that the distortion aberration according to the nineth embodiment is maintained within a range of ±5%.

It can be seen from the above description that the system length of the nineth embodiment is shorter than the first embodiment, and the distortion according to the nineth embodiment is better than the first embodiment. Also, the nineth embodiment also has a greater image height.

In summary, when the optical lens assembly 10 satisfies EDmax/EDmin≤2.100, the chief ray and the marginal ray emitted by the multiple light source generating unit 15 may be effectively collected from the light input side A2 to be projected to the light output side A1 with a high ratio to improve the projection effect. When each embodiment meets the conditions that the first lens element 1 has negative refracting power, the fourth lens element 4 has negative refracting power, the periphery region 516 of the light output surface 51 of the fifth lens element 5 is concave, and the periphery region 626 of the light input surface 62 of the sixth lens element 6 is convex, rays at different angles may be converged, and the aberration of the central field of view of the projected imaging plane may be corrected. In addition, when the surface shape of the periphery region of a specific lens element is matched and the conditional expression V1+V2+V3≤140 is satisfied, the optical lens assembly 10 may have improved projection quality and improved chromatic aberration. In some embodiments, a preferable limit may be 97≤V1+V2+V3≤131.

In some embodiments, when the conditions that the second lens element 2 has positive refracting power and the fifth lens element 5 has positive refracting power are further satisfied, the assembly yield and the imaging quality may be further improved.

In some embodiments, when the optical lens assembly 10 satisfies EDmax/EDmin≤2.100, and further meets the conditions that the first lens element 1 has negative refracting power, the optical axis region 115 of the light output surface 11 of the first lens element 1 is convex, the fourth lens element 4 has negative refracting power, the periphery region 516 of the light output surface 51 of the fifth lens element 5 is concave, and the optical axis region 625 of the light input surface 62 of the sixth lens element 6 is concave, rays at different angles may be converged, and the aberration of the central field of view of the imaging plane of the projection image may be corrected. In addition, when the surface shape of the periphery region of a specific lens element is matched and the conditional expression V1+V3≤100 is satisfied, the optical lens assembly 10 may have improved projection quality and improved chromatic aberration. In some embodiments, a preferable limit is 56≤V1+V3≤94. In addition, when the conditions that the second lens element 2 has positive refracting power and the fifth lens element 5 has positive refracting power are further satisfied, the assembly yield and the imaging quality may be improved.

In some embodiments, when the optical lens assembly 10 satisfies EDmax/EDmin≤2.100, and further meets the conditions that the first lens element 1 has negative refracting power, the optical axis region 115 of the light output surface 11 of the first lens element 1 is convex, the periphery region 216 of the light output surface 21 of the second lens element 2 is convex, the fourth lens element 4 has negative refracting power, and the optical axis region 625 of the light input surface 62 of the sixth lens element 6 is concave and the periphery region 626 is convex, rays at different angles may be converged, and the aberration of the central field of view of the imaging plane of the projection image may be corrected. In addition, when the surface shape of the periphery region of a specific lens element is matched and the conditional expression V1+V3≤100 is satisfied, the optical lens assembly 10 may have improved projection quality and improved chromatic aberration. In some embodiments, a preferable limit is 56≤V1+V3≤94. In addition, when the conditions that the second lens element 2 has positive refracting power and the fifth lens element 5 has positive refracting power are further satisfied, the assembly yield and the imaging quality may be improved.

In some embodiments, when the materials of the first lens element 1 to the sixth lens element 6 meet the following configuration relationship, the transmission and the deflection of imaging rays may be facilitated, while effectively improving chromatic aberration, so that the projection lens matched with the optical lens assembly 10 has excellent optical quality. For example, V1+V2+V4≤150; and V1+V4≤123. Preferable limits are 79≤V1+V2+V4≤150; and 38≤V1+V4≤112.

The optical lens assembly 10 of the disclosure may further satisfy the following conditional expressions, so that the effective focal length and various optical parameters may be maintained at appropriate values to prevent any parameter from being too large and not conducive to the correction of the aberration of the entire optical lens assembly 10 or prevent any parameter from being too small and affecting assembly or increasing the difficulty of manufacturing. For example, TTL/EFL≤1.600; 3.800≤TTL/BFL; 2.900≤EFL/BFL; 4.700≤(ImgH+T2+G23+T3+T5+G56+T6)/BFL; 4.700≤(EFL+T2+G23+T3+T5+G56+T6)/(G34+T4+G45+T5); 2.800≤ImgH*Fno/(G34+T4+G45+T5); 3.900≤ImgH*Fno/BFL; 6.800≤EFL*Fno/(T1+G12); and 2.900≤(ImgH+G56)/BFL. Preferable limits are 1.200≤TTL/EFL≤1.500; 4.300≤TTL/BFL≤7.800; 3.300≤EFL/BFL≤5.400; 5.200≤(ImgH+T2+G23+T3+T5+G56+T6)/BFL≤8.600; 5.200≤(EFL+T2+G23+T3+T5+G56+T6)/(G34+T4+G45+T5)≤9.800; 3.100≤ImgH*Fno/(G34+T4+G45+T5)≤7.500; 4.300≤ImgH*Fno/BFL≤6.000; 7.500≤EFL*Fno/(T1+G12)≤19.400; and 3.200≤(ImgH+G56)/BFL≤5.200.

In some embodiments, when the optical lens assembly 10 of the disclosure may further satisfy the following conditional expressions, the thicknesses of and the spacings between the lens elements may be maintained at appropriate values to prevent any parameter from being too large and not conducive to the thinning of the overall optical lens assembly 10 or prevent any parameter from being too small and affecting assembly or increasing the difficulty of manufacturing. For example, 6.100≤TTL/(T1+G12+G34); 3.600≤TTL/(G34+T4+G45+T5); 1.800≤(T2+G23+T3+G56)/(T4+G45+T5); 2.300≤(T2+G23+T3)/(T1+G12); 2.300≤(T2+G23+T3+T5+G56+T6)/BFL; 6.300≤(T2+G23+T3+G56)*Fno/(T1+G12+G34); 5.000≤TL/(G12+G34+G45); 3.300≤ALT/(T1+T4); 6.500≤ALT/(G12+G34); 4.800≤(T2+T3+G56)/(G12+G34); and 1.800≤(T2+T3+T4+T5+T6)/BFL. Preferable limits are 6.8≤TTL/(T1+G12+G34)≤12.400; 4.100≤TTL/(G34+T4+G45+T5)≤7.400; 2.100≤(T2+G23+T3+G56)/(T4+G45+T5)≤4.000; 2.500≤(T2+G23+T3)/(T1+G12)≤4.800; 2.600≤(T2+G23+T3+T5+G56+T6)/BFL≤4.700; 7.000≤(T2+G23+T3+G56)*Fno/(T1+G12+G34)≤16.000; 5.500≤TL/(G12+G34+G45)≤21.500; 3.700≤ALT/(T1+T4)≤4.700; 7.300≤ALT/(G12+G34)≤27.600; 5.300≤(T2+T3+G56)/(G12+G34)≤23.000; and 2.000≤(T2+T3+T4+T5+T6)/BFL≤3.800.

In addition, any combination of the parameters of the embodiments may be selected to increase the limitation of the optical lens elements, so as to facilitate the design of the optical lens assembly with the same architecture as the disclosure.

In view of the unpredictability of the design of the optical system, under the architecture of the disclosure, satisfying the above conditions can preferably shorten the system length, increase the available aperture, improve the optical quality, or increase the assembly yield of the disclosure to improve the shortcomings of the prior art.

The exemplary limiting relational expressions listed above may also be arbitrarily and selectively combined in different quantities and applied to the implementations of the disclosure, and are not limited thereto. When implementing the disclosure, in addition to the above relational expressions, other detailed structures such as the arrangement of concave-convex curved surfaces of more lens elements may also be designed for a single lens element or more extensively for multiple lens elements to enhance the control of the system performance and/or resolution. It should be noted that such details need to be selectively combined and applied to other embodiments of the disclosure without conflict.

The numerical ranges obtained by the combination ratio relationship of the optical parameters disclosed in each embodiment of the disclosure, including the maximum and minimum values, may be implemented accordingly.

The contents in the embodiments of the invention include but are not limited to a focal length, a thickness of a lens element, an Vd Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:

The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.

The comparative relation between the optical parameters is that A is greater than B or A is less than B, for example.

The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

What is claimed is:

1. An optical lens assembly, adapted to a projection lens, and the optical lens assembly being configured to generate a plurality of beams from a plurality of lights emitted by a multiple light source generating unit via the optical lens assembly, wherein a direction toward the multiple light source generating unit is a light input side, and an opposite side is a light output side, the optical lens assembly comprises a first lens element, a second lens element, a third lens element, a fourth lens element, a fifth lens element, and a sixth lens element sequentially along an optical axis from the light output side to the light input side, and each of the first lens element, the second lens element, the third lens element, the fourth lens element, the fifth lens element, and the sixth lens element comprises a light output surface facing the light output side and a light input surface facing the light input side, wherein
the projection lens satisfies a following conditional expression: EDmax/EDmin≤2.100;
the first lens element has negative refracting power;
the fourth lens element has negative refracting power;
a periphery region of the light output surface of the fifth lens element is concave;
a periphery region of the light input surface of the sixth lens element is convex;
lens elements of the optical lens assembly are only the six lens elements and satisfy a following conditional expression: V1+V2+V3≤140, where EDmax is a maximum effective diameter of the first lens element to the sixth lens element, EDmin is a minimum effective diameter of the first lens element to the sixth lens element, V1 is a Vd Abbe number of the first lens element, V2 is a Vd Abbe number of the second lens element, and V3 is a Vd Abbe number of the third lens element.

2. The optical lens assembly according to claim 1, wherein the optical lens assembly further satisfies a following conditional expression: TTL/EFL≤1.600, where TTL is a distance from the light output surface of the first lens element to a light emitting surface of the multiple light source generating unit on the optical axis, and EFL is an effective focal length of the optical lens assembly.

3. The optical lens assembly according to claim 1, wherein the optical lens assembly further satisfies a following conditional expression: 4.700≤(EFL+T2+G23+T3+T5+G56+T6)/(G34+T4+G45+T5), where EFL is an effective focal length of the optical lens assembly, T2 is a thickness of the second lens element on the optical axis, T3 is a thickness of the third lens element on the optical axis, T4 is a thickness of the fourth lens element on the optical axis, T5 is a thickness of the fifth lens element on the optical axis, T6 is a thickness of the sixth lens element on the optical axis, G23 is an air gap between the second lens element and the third lens element on the optical axis, G34 is an air gap between the third lens element and the fourth lens element on the optical axis, G45 is an air gap between the fourth lens element and the fifth lens element on the optical axis, and G56 is an air gap between the fifth lens element and the sixth lens element on the optical axis.

4. The optical lens assembly according to claim 1, wherein the optical lens assembly further satisfies a following conditional expression: 3.600≤TTL/(G34+T4+G45+T5), where TTL is a distance from the light output surface of the first lens element to a light emitting surface of the multiple light source generating unit on the optical axis, G34 is an air gap between the third lens element and the fourth lens element on the optical axis, G45 is an air gap between the fourth lens element and the fifth lens element on the optical axis, T4 is a thickness of the fourth lens element on the optical axis, and T5 is a thickness of the fifth lens element on the optical axis.

5. The optical lens assembly according to claim 1, wherein the optical lens assembly further satisfies a following conditional expression: 3.900≤ImgH*Fno/BFL, where ImgH is a maximum image height of the optical lens assembly, Fno is an F-number of the optical lens assembly, and BFL is a distance from the light input surface of the sixth lens element to a light emitting surface of the multiple light source generating unit on the optical axis.

6. The optical lens assembly according to claim 1, wherein the optical lens assembly further satisfies a following conditional expression: 1.800≤(T2+G23+T3+G56)/(T4+G45+T5), where T2 is a thickness of the second lens element on the optical axis, T3 is a thickness of the third lens element on the optical axis, T4 is a thickness of the fourth lens element on the optical axis, T5 is a thickness of the fifth lens element on the optical axis, G23 is an air gap between the second lens element and the third lens element on the optical axis, G45 is an air gap between the fourth lens element and the fifth lens element on the optical axis, and G56 is an air gap between the fifth lens element and the sixth lens element on the optical axis.

7. The optical lens assembly according to claim 1, wherein the optical lens assembly further satisfies a following conditional expression: 2.300≤(T2+G23+T3)/(T1+G12), where T1 is a thickness of the first lens element on the optical axis, T2 is a thickness of the second lens element on the optical axis, T3 is a thickness of the third lens element on the optical axis, G12 is an air gap between the first lens element and the second lens element on the optical axis, and G23 is an air gap between the second lens element and the third lens element on the optical axis.

8. An optical lens assembly, adapted to a projection lens, and the optical lens assembly being configured to generate a plurality of beams from a plurality of lights emitted by a multiple light source generating unit via the optical lens assembly, wherein a direction toward the multiple light source generating unit is a light input side, and an opposite side is a light output side, the optical lens assembly comprises a first lens element, a second lens element, a third lens element, a fourth lens element, a fifth lens element, and a sixth lens element sequentially along an optical axis from the light output side to the light input side, and each of the first lens element, the second lens element, the third lens element, the fourth lens element, the fifth lens element, and the sixth lens element comprises a light output surface facing the light output side and a light input surface facing the light input side, wherein
the projection lens satisfies a following conditional expression: EDmax/EDmin≤2.100;
the first lens element has negative refracting power; an optical axis region of the light output surface of the first lens element is convex;
the fourth lens element has negative refracting power;
a periphery region of the light output surface of the fifth lens element is concave;
an optical axis region of the light input surface of the sixth lens element is concave;
lens elements of the optical lens assembly are only the six lens elements and satisfy a following conditional expression: V1+V3≤100, wherein EDmax is a maximum effective diameter of the first lens element to the sixth lens element, EDmin is a minimum effective diameter of the first lens element to the sixth lens element, V1 is a Vd Abbe number of the first lens element, and V3 is a Vd Abbe number of the third lens element.

9. The optical lens assembly according to claim 8, wherein the optical lens assembly further satisfies a following conditional expression: 2.900≤EFL/BFL, where EFL is an effective focal length of the optical lens assembly, and BFL is a distance from the light input surface of the sixth lens element to a light emitting surface of the multiple light source generating unit on the optical axis.

10. The optical lens assembly according to claim 8, wherein the optical lens assembly further satisfies a following conditional expression: 2.300≤(T2+G23+T3+T5+G56+T6)/BFL, where T2 is a thickness of the second lens element on the optical axis, T3 is a thickness of the third lens element on the optical axis, T5 is a thickness of the fifth lens element on the optical axis, T6 is a thickness of the sixth lens element on the optical axis, G23 is an air gap between the second lens element and the third lens element on the optical axis, G56 is an air gap between the fifth lens element and the sixth lens element on the optical axis, and BFL is a distance from the light input surface of the sixth lens element to a light emitting surface of the multiple light source generating unit on the optical axis.

11. The optical lens assembly according to claim 8, wherein the optical lens assembly further satisfies a following conditional expression: 4.700≤(ImgH+T2+G23+T3+T5+G56+T6)/BFL, where ImgH is a maximum image height of the optical lens assembly, T2 is a thickness of the second lens element on the optical axis, T3 is a thickness of the third lens element on the optical axis, T5 is a thickness of the fifth lens element on the optical axis, T6 is a thickness of the sixth lens element on the optical axis, G23 is an air gap between the second lens element and the third lens element on the optical axis, G56 is an air gap between the fifth lens element and the sixth lens element on the optical axis, and BFL is a distance from the light input surface of the sixth lens element to a light emitting surface of the multiple light source generating unit on the optical axis.

12. The optical lens assembly according to claim 8, wherein the optical lens assembly further satisfies a following conditional expression: 6.100≤TTL/(T1+G12+G34), where TTL is a distance from the light output surface of the first lens element to a light emitting surface of the multiple light source generating unit on the optical axis, T1 is a thickness of the first lens element on the optical axis, G12 is an air gap between the first lens element and the second lens element on the optical axis, and G34 is an air gap between the third lens element and the fourth lens element on the optical axis.

13. The optical lens assembly according to claim 8, wherein the optical lens assembly further satisfies a following conditional expression: 2.800≤ImgH*Fno/(G34+T4+G45+T5), where ImgH is a maximum image height of the optical lens assembly, Fno is an F-number of the optical lens assembly, G34 is an air gap between the third lens element and the fourth lens element on the optical axis, G45 is an air gap between the fourth lens element and the fifth lens element on the optical axis, T4 is a thickness of the fourth lens element on the optical axis, and T5 is a thickness of the fifth lens element on the optical axis.

14. The optical lens assembly according to claim 8, wherein the optical lens assembly further satisfies a following conditional expression: 3.800≤TTL/BFL, where TTL is a distance from the light output surface of the first lens element to a light emitting surface of the multiple light source generating unit on the optical axis, and BFL is a distance from the light input surface of the sixth lens element to the light emitting surface of the multiple light source generating unit on the optical axis.

15. An optical lens assembly, adapted to a projection lens, and the optical lens assembly being configured to generate a plurality of beams from a plurality of lights emitted by a multiple light source generating unit via the optical lens assembly, wherein a direction toward the multiple light source generating unit is a light input side, and an opposite side is a light output side, the optical lens assembly comprises a first lens element, a second lens element, a third lens element, a fourth lens element, a fifth lens element, and a sixth lens element sequentially along an optical axis from the light output side to the light input side, and each of the first lens element, the second lens element, the third lens element, the fourth lens element, the fifth lens element, and the sixth lens element comprises a light output surface facing the light output side and a light input surface facing the light input side, wherein
the projection lens satisfies a following conditional expression: EDmax/EDmin≤2.100;
the first lens element has negative refracting power; an optical axis region of the light output surface of the first lens element is convex;
a periphery region of the light output surface of the second lens element is convex;
the fourth lens element has negative refracting power;
an optical axis region of the light input surface of the sixth lens element is concave; a periphery region of the light input surface of the sixth lens element is convex;
lens elements of the optical lens assembly are only the six lens elements and satisfy a following conditional expression: V1+V3≤100, wherein EDmax is a maximum effective diameter of the first lens element to the sixth lens element, EDmin is a minimum effective diameter of the first lens element to the sixth lens element, V1 is a Vd Abbe number of the first lens element, and V3 is a Vd Abbe number of the third lens element.

16. The optical lens assembly according to claim 15, wherein the optical lens assembly further satisfies a following conditional expression: 6.800≤EFL*Fno/(T1+G12), where EFL is an effective focal length of the optical lens assembly, Fno is an F-number of the optical lens assembly, T1 is a thickness of the first lens element on the optical axis, and G12 is an air gap between the first lens element and the second lens element on the optical axis.

17. The optical lens assembly according to claim 15, wherein the optical lens assembly further satisfies a following conditional expression: 2.900≤(ImgH+G56)/BFL, where ImgH is a maximum image height of the optical lens assembly, G56 is an air gap between the fifth lens element and the sixth lens element on the optical axis, and BFL is a distance between the light input surface of the sixth lens element and a light emitting surface of the multiple light source generating unit on the optical axis.

18. The optical lens assembly according to claim 15, wherein the optical lens assembly further satisfies a following conditional expression: 6.300≤(T2+G23+T3+G56)*Fno/(T1+G12+G34), where T1 is a thickness of the first lens element on the optical axis, T2 is a thickness of the second lens element on the optical axis, T3 is a thickness of the third lens element on the optical axis, G12 is an air gap between the first lens element and the second lens element on the optical axis, G23 is an air gap between the second lens element and the third lens element on the optical axis, G34 is an air gap between the third lens element and the fourth lens element on the optical axis, G56 is an air gap between the fifth lens element and the sixth lens element on the optical axis, and Fno is an F-number of the optical lens assembly.

19. The optical lens assembly according to claim 15, wherein the optical lens assembly further satisfies a following conditional expression: 5.000≤TL/(G12+G34+G45), where TL is a distance from the light output surface of the first lens element to the light input surface of the sixth lens element on the optical axis, G12 is an air gap between the first lens element and the second lens element on the optical axis, G34 is an air gap between the third lens element and the fourth lens element on the optical axis, and G45 is an air gap between the fourth lens element and the fifth lens element on the optical axis.

20. The optical lens assembly according to claim 15, wherein the optical lens assembly further satisfies a following conditional expression: 3.300≤ALT/(T1+T4), where ALT is a sum of thicknesses of the six lens elements on the optical axis, T1 is a thickness of the first lens element on the optical axis, and T4 is a thickness of the fourth lens element on the optical axis.
